(19) United States
(12) Patent Application Publication
(10) Pub. No.: US 2026/0084466 A1
(43) Pub. Date: Mar. 26, 2026

(54) PNEUMATIC TIRE

(71) Applicant: Toyo Tire Corporation, Itami-shi (JP)

(72) Inventors: Tetsuji Miyazaki, Itami-shi (JP); Hikaru Kuriyama, Itami-shi (JP); Tsubasa Miyagaki, Itami-shi (JP)

(73) Assignee: Toyo Tire Corporation, Itami-shi (JP)

(21) Appl. No.: 19/325,878

(22) Filed: Sep. 11, 2025

(30) Foreign Application Priority Data
Sep. 26, 2024 (JP) 2024-166959
Sep. 26, 2024 (JP) 2024-166960
Sep. 26, 2024 (JP) 2024-166961
Sep. 26, 2024 (JP) 2024-166962
Sep. 26, 2024 (JP) 2024-166963
Sep. 26, 2024 (JP) 2024-166964

(51) Int. Cl. B60C 11/03; B60C 11/12

(52) U.S. Cl. CPC B60C 11/0306; B60C 11/1218; B60C 2011/0339; B60C 2011/1213

(57) ABSTRACT

A pneumatic tire is provided that achieves improved drainage property over conventional. A slit formed in a tread includes a first slit formed in a state continuously extending from an outside intermediate land spanning a central land, an inside intermediate land and an inside shoulder land, the first slit including a first curved portion within a range from the outside intermediate land through the central land to a middle of the inside intermediate land that curves to the tire-circumferential direction other side, and including a second curved portion within a range from a middle of the inside intermediate land to the inside shoulder land that curves to the opposite side than the first curved portion in the tire-circumferential direction, i.e. tire-circumferential direction other side.

This application is based on and claims the benefit of priority from Japanese Patent Application Nos. 2024-166959 and 2024-166960, 2024-166961, 2024-166962, 2024-166963, 2024-166964, respectively filed on 26 Sep. 2024, the contents of which are incorporated herein by reference.

### BACKGROUND OF THE INVENTION

### Field of the Invention

The present invention relates to a pneumatic tire.

### Related Art

Conventionally, pneumatic tires have been known that include tread including a plurality of main grooves extending in the tire-circumferential direction and a plurality of lands extending in the tire-circumferential direction between the main grooves, and in which various grooves are formed in the lands (for example, refer to Patent Documents 1, etc.).
Patent Document 1: Japanese Unexamined Patent Application, Publication No. 2021-30790

### SUMMARY OF THE INVENTION

In this type of tire, although the traction performance such as during rainy weather is ensured by the drainage performance improving due to the main grooves; however, in addition to this, drainage is performed by grooves such as slits formed in the lands and extending in directions intersecting the tire-circumferential direction.

The present invention has an object of providing a pneumatic tire for which an improvement in drainage performance over conventional is achieved.

A pneumatic tire of the present invention includes a tread including: a plurality of lands extending in a tire-circumferential direction and aligned in a tire-axial direction; a plurality of main grooves provided between a plurality of the lands, and a slit provided in the land, in which the plurality of the lands includes a central land, a first intermediate land on a tire-axial direction one side of the central land, a second intermediate land on a tire-axial direction other side of the central land, a first shoulder land on the tire-axial direction one side of the first intermediate land, and a second shoulder land on the tire-axial direction other side of the first intermediate land; the plurality of the main grooves includes a first central main groove between the central land and the first intermediate land, a second central main groove between the central land and the second intermediate land, a first shoulder main groove between the first intermediate land and the first shoulder land, and a second shoulder main groove between the second intermediate land and the second shoulder land; the slit includes a first slit formed in a state continuously extending from the first intermediate land and spanning the central land, the second intermediate land and the second shoulder land; and the first slit includes a first curved portion that curves to either side in a tire-circumferential direction within a range from the first intermediate land through the central land to a middle of the second intermediate land, and includes a second curved portion that curves to an opposite side than the first curved portion in the tire-circumferential direction, within a range from middle of the second intermediate land to the second shoulder land.

According to the present invention, it is possible to provide a pneumatic tire for which an improvement in drainage performance over conventional is achieved.

### BRIEF DESCRIPTION OF THE DRAWINGS

FIG. 1 is a partial enlarged front view showing a tread surface of a tire according to an embodiment;

FIG. 2 is an enlarged view of a portion indicated by II in FIG. 1;

FIG. 3A is a cross-sectional view along IIIA-IIIA in FIG. 2;

FIG. 3B is a cross-sectional view along IIIB-IIIB in FIG. 2;

FIG. 3C is a cross-sectional view along IIIC-IIIC in FIG. 2;

FIG. 3D is a cross-sectional view along IIID-IIID in FIG. 2;

FIG. 4 is a view corresponding to FIG. 2, and showing an example having a low land portion in an enclosed region of a central land;

FIG. 5A is a view corresponding to the V-V section in FIG. 4, and showing an example of a low land portion;

FIG. 5B is a view corresponding to the V-V section in FIG. 4, and showing another example of a low land portion;

FIG. 6 is an enlarged view of a portion indicated by VI in FIG. 1;

FIG. 7A is a cross-sectional view along VIIA-VIIA in FIG. 6;

FIG. 7B is a cross-sectional view along VIIB-VIIB in FIG. 6;

FIG. 7C is a cross-sectional view along VIIC-VIIC in FIG. 6;

FIG. 7D is a cross-sectional view along VIID-VIID in FIG. 6;

FIG. 8 is an enlarged view of a portion indicated by VIII in FIG. 1;

FIG. 9 is an enlarged view of a portion indicated by IX in FIG. 1;

FIG. 10A is a cross-sectional view along XA-XA in FIG. 9;

FIG. 10B is a cross-sectional view along XB-XB in FIG. 9;

FIG. 10C is a cross-sectional view along XC-XC in FIG. 9;

FIG. 10D is a cross-sectional view along XD-XD in FIG. 9;

FIG. 11A is a cross-sectional view along XIA-XIA in FIG. 9;

FIG. 11B is a cross-sectional view along XIB-XIB in FIG. 9;

FIG. 11C is a cross-sectional view along XIC-XIC in FIG. 9;

FIG. 12 is a view schematically showing an outside shoulder sipe according to an embodiment in a state viewed from a lateral surface direction;

FIG. 13A is a plan view schematically viewing an opening in a tire surface of the outside shoulder sipe of the embodiment;

FIG. 13B is a view corresponding to a cross section along XIIIB-XIIIB of FIG. 12, and showing an outside shoulder sipe;

FIG. 13C is a view corresponding to a cross section along XIIIC-XIIIC of FIG. 12, and showing an outside shoulder sipe;

FIG. 14A is a view corresponding to a cross section along XIVA-XIVA in FIG. 12, and showing an outside shoulder sipe;

FIG. 14B is a view corresponding to a cross section along XIVB-XIVB in FIG. 12, and showing an outside shoulder sipe;

FIG. 15 is a view schematically showing a wave-shaped portion of the inside shoulder sipe and a portion of a sipe bridge according to the embodiment in a state viewed from a lateral surface direction;

FIG. 16A is a plan view schematically showing an opening in the tire surface of the inside shoulder sipe of the embodiment;

FIG. 16B is a view corresponding to a cross section along XVIB-XVIB in FIG. 15, and showing an inside shoulder sipe; and

FIG. 17 is a view corresponding to a cross section along XVII-XVII in FIG. 15, and showing an inside shoulder sipe.

### DETAILED DESCRIPTION OF THE INVENTION

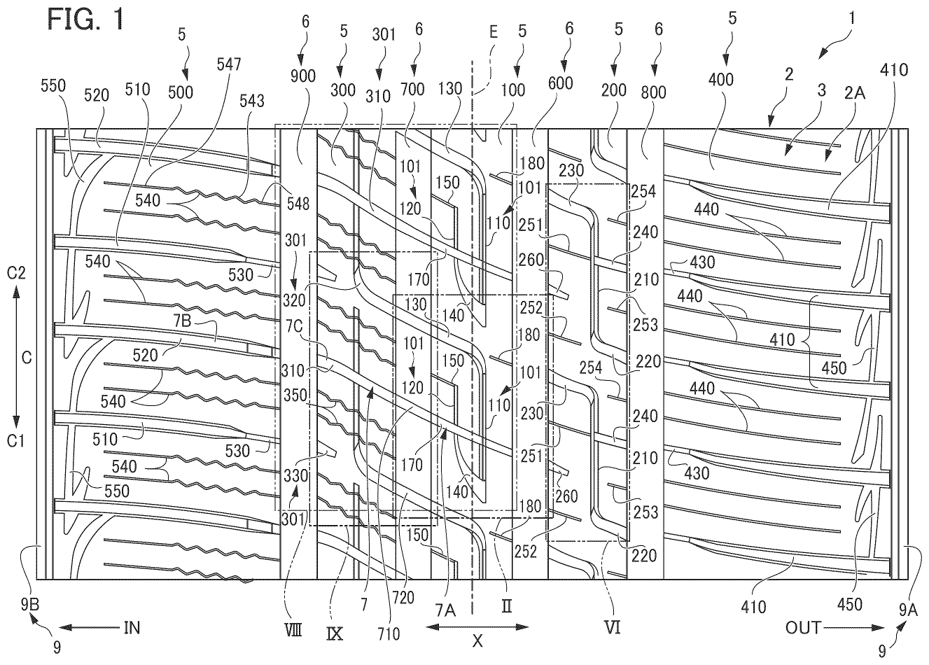

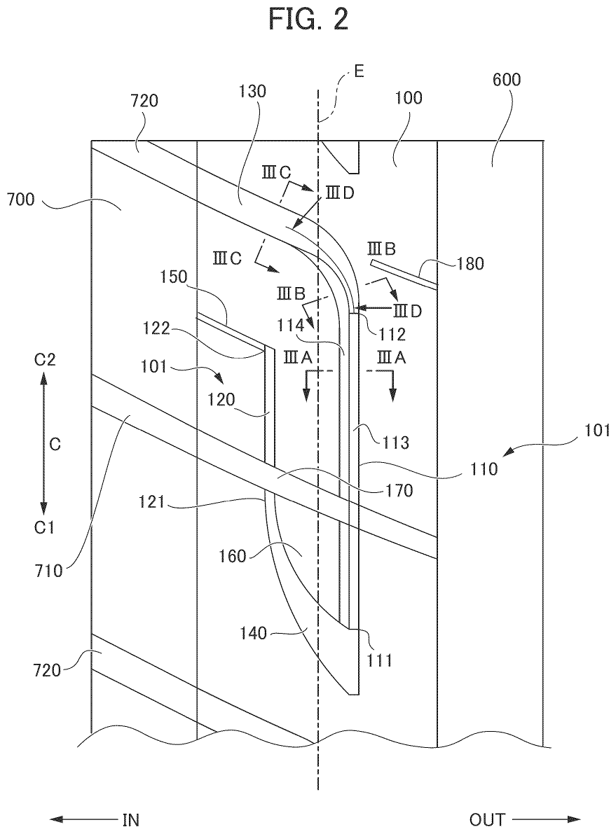

Hereinafter, an embodiment will be described by referencing the drawings. FIG. 1 is a partial enlarged view of a front view of a tire 1 as a pneumatic tire according to an embodiment. FIG. 2 is an enlarged view of a portion indicated by II in FIG. 1, and showing a central land 100 described later. The tire 1 according to the embodiment is a pneumatic tire for passenger vehicles, for example. It should be noted that the configuration of the tire 1 according to the embodiment can be adopted for various vehicles such as light trucks, trucks and buses, in addition to passenger vehicles.

In FIG. 1, the tire-width direction X, tire-circumferential direction C and the tire equator E are shown. The tire equator E is a virtual line extending a center in the tire-axial direction along the tire-circumferential direction. FIG. 1 indicates one side in the tire-circumferential direction C (lower side in FIG. 1) by the arrow C1, and indicates the other side (upper side in FIG. 1) by the arrow C2. It should be noted that these reference symbols also apply to FIGS. 2, 4, 6 and 7.

FIG. 1 shows tread 2 of the tire 1 according to the embodiment. The tread 2 includes a tread surface 2A which is an outer circumferential surface of the tire 1, and makes contact with the road surface. In this tread surface 2A, a tread pattern 3 is formed by a plurality of types of lands and grooves.

Various main grooves, minor grooves, slits, lug grooves, sipes, etc. are included as the grooves forming the tread pattern 3. The main grooves and minor grooves are grooves following the tire-circumferential direction, and the slits, lug grooves and sipes are grooves extending in a direction intersecting the tire-circumferential direction. Regarding the width of these grooves, the width of the main grooves is the largest, and the sipes are the smallest. The widths of various sipes in the embodiment, for example, are on the order of 0.4 mm or more and 1.0 mm or less, and the depths are on the order of 5 mm or more and 11 mm or less, for example, but are not limited thereto. The respective widths of the minor grooves, slits, and lug grooves are common in the point of being smaller than the major groove, and being equal to the sipes or larger than the sipes; however, they may have similar widths or may differ.

The tread pattern 3 of the embodiment is non-symmetrical in the tire-axial direction. For the tire 1, the side arranged at the outer side in the vehicle-width direction of the vehicle and the side arranged on the inner side in the vehicle-width direction of the vehicle are designated in the orientation mounted to the vehicle, i.e. state mounted to the vehicle. The orientation mounted to the vehicle is based on the tread pattern 3. FIG. 1 indicates the outer side in the vehicle-width direction by “OUT”, and indicates the inner side in the vehicle-width direction by “IN”. In other words, in FIG. 1, the right side of the page is the outer side in the vehicle-width direction outside, and the left side of the page is the inner side in the vehicle-width direction. In FIG. 1, the tire-axial direction X and a vehicle-width direction are parallel. FIG. 1 is a front view of a state in which the tire 1 is mounted to the vehicle, i.e. when viewing the tire 1 from the vehicle front side. It should be noted that the outer side in the vehicle-width direction and the inner side in the vehicle-width direction are similarly indicated in FIGS. 2, 4, 6, 8 and 9.

As shown in FIG. 1, the tire 1 of the embodiment includes sidewalls 9 extending in the tire-radial direction (direction of the back side of the page in FIG. 1) toward a bead (not shown) at both sides in the tire-axial direction of the tread 2. The sidewalls 9 include an outside sidewall 9a on the outer side in the vehicle-width direction, and an inside sidewall 9B on the inner side in the vehicle-width direction.

The tread 2 includes a plurality of lands 5 lined up in the tire-width direction, and a plurality of main grooves 6 between the lands 5. Each of the lands 5 is a rib-shaped convex part extending in the tire-circumferential direction. Each of the main grooves 6 is a circumferential groove extending in the tire-circumferential direction.

The plurality of the lands 5 include central lands 100 arranged at the center in the tire-axial direction, outside intermediate lands 200 arranged on the outer side in the vehicle-width direction of the central land 100, inside intermediate lands 300 arranged on the inner side in vehicle-width direction of the central lands 100, outside shoulder lands 400 arranged on the outer side in the vehicle-width direction of the outside intermediate lands 200, and inside shoulder lands 500 arranged on the inner side in the vehicle-width direction of the inside intermediate lands 300. The outside intermediate land 200 is an example of a first intermediate land of the present disclosure, and the inside intermediate land 300 is an example of a second intermediate land of the present disclosure. The outside shoulder land 400 is an example of a first shoulder land of the present disclosure, and the inside shoulder land 500 is an example of a second shoulder land of the present disclosure.

The widths of the three lands 5 of the central land 100, outside intermediate land 200 and inside intermediate land 300, for example, are on the order of 18 mm or more and 50 mm or less, but are not limited thereto.

The widths of the three lands 5 of the central land 100, the outside intermediate land 200 and the inside intermediate land 300 of the embodiment are the same; however, two of these may be the same and the other differing, or the three may be completely different. The widths of the outside shoulder land 400 and the inside shoulder land 500 of the embodiment are larger than the widths of the central land 100, the outside intermediate land 200 and the inside intermediate land 300. The widths of the outside shoulder land 400 and the inside shoulder land 500 of the embodiment are the same, but may be different.

The plurality of main grooves 6 includes an outside central main groove 600 between the central land 100 and the outside intermediate land 200, an inside central main groove 700 between the central land 100 and the inside intermediate land 300, an outside shoulder main groove 800 between the outside intermediate land 200 and the outside shoulder land 400, and an inside shoulder main groove 900 between the inside intermediate land 300 and the inside shoulder land 500. The outside central main groove 600 is an example of the first central main groove of the present disclosure, and the inside central main groove 700 is an example of the second central main groove of the present disclosure. The outside shoulder main groove 800 is an example of the first shoulder main groove of the present disclosure, and the inside shoulder main groove 900 is an example of the second shoulder main groove of the present disclosure. The width of each main groove 6 is on the order of 4 mm or more and 18 mm or less, for example, and the depth of each main groove 6 is on the order of 8 mm or more and 13 mm or less, for example, but are not limited thereto.

The width of the outside central main groove 600 and the width of the inside central main groove 700 in the embodiment are the same. The width of the outside shoulder main groove 800 and the width of the inside shoulder main groove 900 are the same, and slightly larger than the widths of the outside central main groove 600 and the inside central main groove 700. The widths of the outside shoulder main groove 800 and the inside shoulder main groove 900 are on the order of 10% larger relative to the widths of the outside central main groove 600 and the inside central main groove 700, for example.

The central land 100 includes a plurality of central minor grooves 101 on the surface thereof. The plurality of central minor grooves 101 are arranged at intervals in the tire-circumferential direction at substantially the center in the width direction of the center lands.

The central minor grooves 101 include a plurality of first minor grooves 110 and a plurality of second minor grooves 120. The first minor grooves 110 and the second minor grooves 120 all extend linearly along the tire-circumferential direction. The widths of the first minor grooves 110 and the second minor grooves 120 are on the order of 1 mm or more and 5 mm or less, for example, and the depths are on the order of 1 mm or more and 7 mm or less, for example; however, they are not limited thereto.

As shown in FIG. 2, the first minor grooves 110 are arranged at the outer side in the vehicle-width direction of the tire equator E. The first minor groove 110 includes one end 111 at a tire-circumferential direction one side C1 and one other end 112 at a tire-circumferential direction other side C2. The one end 111 and other end 112 are both ends of the linear first minor groove 110. A plurality of the first minor grooves 110 are arranged at intervals in the tire-circumferential direction.

The central land 100 includes a first sloped groove 130. The sloped groove 130 is an example of the second slit of the present disclosure, which is substantially parallel to the first slit 7 described later, extends in a direction intersecting the tire-circumferential direction C, and one end thereof exists within a land. The width of the first sloped groove 130 is on the order of 1.8 mm or more and 6 mm or less, for example, and the depth is on the order of 6 mm or more and 12 mm or less, for example; however, they are not limited thereto.

The first sloped groove 130 extends from the other end 112 of the first minor groove 110 to the side of the inside central main groove 700, and communicates with the inside central main groove 700. The first sloped groove 130 is configured to form an obtuse angle (91 degrees or more) with the other end 112 of the first minor groove 110 and slopes to the tire-circumferential direction other side C2. The other end 112 of the first minor groove 110 communicates with the inside central main groove 700 via the first sloped groove 130. A groove which is continuous in a substantially inverted L shape is formed by the first minor groove 110 and the first sloped groove 130.

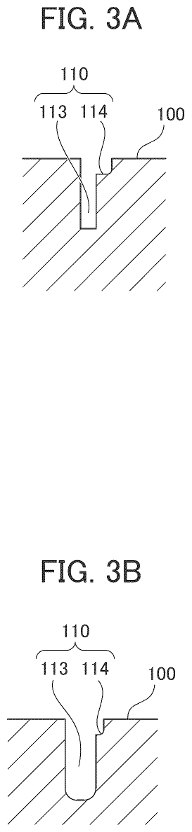

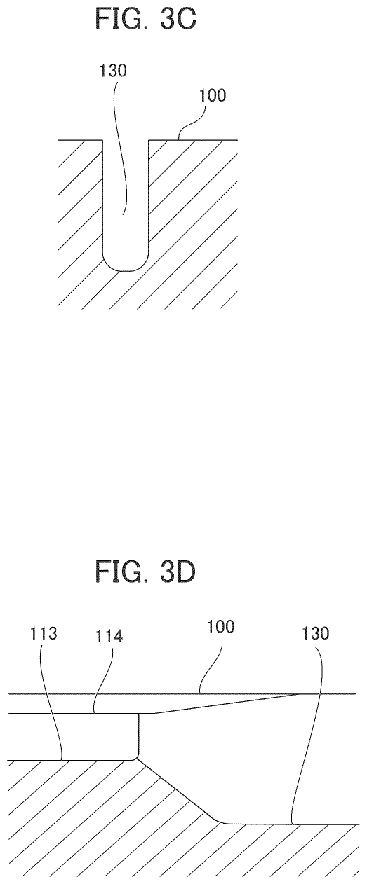

FIG. 3A is a cross-sectional view along IIIA-IIIA in FIG. 2. FIG. 3B is a cross-sectional view along IIIB-IIIB in FIG. 2. FIG. 3C is a cross-sectional view along IIIC-IIIC in FIG. 2. FIG. 3D is a cross-sectional view along IIID-IIID in FIG. 2.

As shown in FIGS. 2 and 3A, the first minor groove 110 includes a first narrow groove 113, and a first shelf 114 provided to one side of the first narrow groove 113 (in this case, inner side in vehicle-width direction). The first narrow groove 113 is a groove having a similar width to each sipe of the embodiment described later. The first shelf 114 is shallower than the first narrow groove 113, and has a form of a stepped shape communicating with the first narrow groove 113. The width of the first shelf 114 has a dimension of the same order as the width of the first narrow groove 113; however, it is not limited thereto.

As shown in FIGS. 2 and 3B, in a portion from the first minor groove 110 towards the first sloped groove 130, the width and depth of the first narrow groove 113 gradually become larger, and the width of the first shelf 114 gradually becomes smaller. As shown in FIG. 2, the first shelf 114 has a width that becomes a tapered shape as approaching the first sloped groove 130 from the first minor groove 110, and disappears when reaching the first sloped groove 130. The width of the first narrow groove 113 becomes large accompanying the disappearance of the first shelf 114, and eventually the first narrow groove 113 leads into the first sloped groove 130 and disappears. FIG. 3C shows a cross section of the first sloped groove 130. As shown in FIG. 3C, the first sloped groove 130 has a larger width and depth than the first narrow groove 113.

FIG. 3D shows a cross section in a groove length direction of a portion from the first minor groove 110 toward the first sloped groove 130. As shown in FIG. 3D, in a portion from the first minor groove 110 toward the first sloped groove 130, the depth of the first narrow groove 113 gradually becomes larger, and the depth of the first shelf 114 gradually become smaller. Then, the first narrow groove 113 becomes the depth of the first sloped groove 130 and disappears, accompanying the disappearance of the first shelf 114.

The second minor groove 120 is more to the inner side in the vehicle-width direction than the tire equator E, and adjacent to the first minor groove 110 on the side of inside central main groove 700. The second minor groove 120 includes one end 121 at the tire-circumferential direction one side C1, and one other end 122 at the tire-circumferential direction other side C2. The one end 121 and other end 122 both are ends of the linear second minor groove 120. A plurality of the second minor grooves 120 are arranged at intervals in the tire-circumferential direction. The second minor groove 120 has a shorter tire-circumferential direction length than the first minor groove 110, and when viewing in the tire-axial direction X, the entire length thereof overlaps with the first minor groove 110. The one end 121 of the second minor groove 120 is located more to the tire-circumferential direction other side C2 than the one end 111 of the first minor groove 110.

The plurality of central minor grooves 101 of the embodiment, i.e. first minor grooves 110 and second minor grooves 120, are arranged at positions dividing the central land 100 into three substantially equal portions in the width direction.

The central land 100 includes a first sipe 150 communicating from the other end 122 of the second minor groove 120 to the inside central main groove 700. The first sipe 150 is substantially parallel to the above-mentioned first sloped groove 130. The width of the first sipe 150, for example, is on the order of 0.6 mm or more and 1.2 mm or less; however, it is not limited thereto.

The one end 111 of the first minor groove 110 and the one end 121 of the second minor groove 120 are connected by a connection groove 140. The first minor groove 110 and the second minor groove 120 are in communication by way of the connection groove 140. The connection groove 140 of the embodiment extends from the one end 111 of the first minor groove 110 to the tire-circumferential direction other side C2 while curving convexly to the inner side in the vehicle-width direction, and joins the one end 121 of the second minor groove 120. In the embodiment, the connection groove 140 assumes a form folding back from the one end 111 of the first minor groove 110 to the tire-circumferential direction other side C2, and at the folding portion thereof, a substantially V-shaped groove is formed by the first minor groove 110 and the connection groove 140. The width of the connection groove 140 gradually becomes smaller as approaching the one end 121 of the second minor groove 120 from the one end 111 of the first minor groove 110.

The central land 100 includes an enclosed region 160 surrounded by grooves including at least the connection groove 140 among the first minor groove 110, second minor groove 120 and connection groove 140. The central land 100 of the embodiment includes the enclosed region 160 surrounded by the first minor groove 110 and the connection groove 140, as shown in FIG. 2. The enclosed region 160 is a tapered shape towards the tire-circumferential direction one side C1.

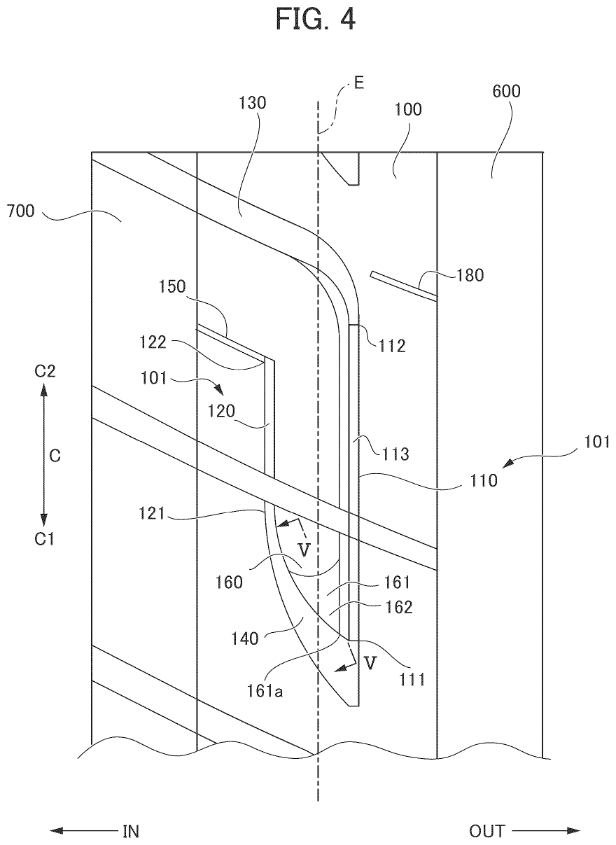

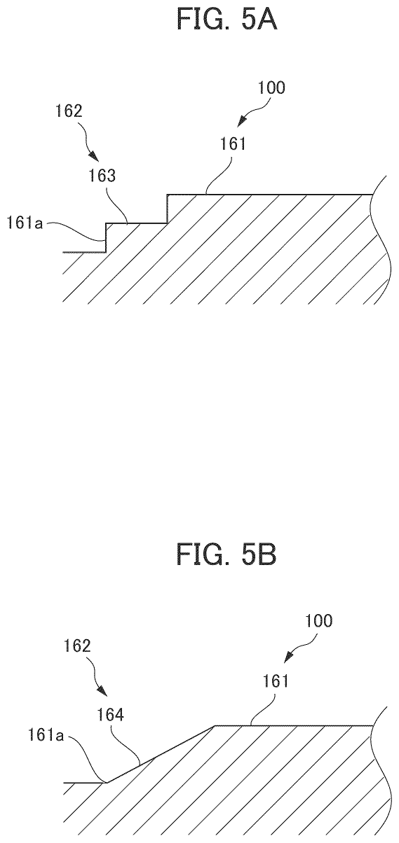

Herein, as shown in FIG. 4, a tip portion 161 forming the tapered shape of the enclosed region 160 may have a low land portion 162 in which the height of the land becomes lower step-wise or gradually, as approaching the tire-circumferential direction one side C1. FIG. 4 is a similar view as FIG. 2, and shows an example having the low land portion 162 in the enclosed region 160. FIGS. 5A and 5B are views respectively showing specific examples of the low land portion 162, and correspond to the cross section V-V in FIG. 4.

The low land portion 162 shown in FIG. 5A is configured by a step 163 at which the height of the land becomes lower step-wise, as approaching the tip 161a of the enclosed region 160.

The low land portion 162 shown in FIG. 5B is configured by a taper surface 164 at which the height of the land becomes gradually lower, as approaching the tip 161a of the enclosed region 160.

By the enclosed region 160 having the low land portion 162 in this way, collapse or chipping is unlikely to occur in the enclosed region 160, and the rigidity of the land is easily secured.

As shown in FIG. 2, the central land 100 includes a first transverse slit 170. In the first transverse slit 170, the width of the first transverse slit 170 is on the order of 1.8 mm or more and 5 mm or less, for example, and the depth is on the order of 6 mm or more and 12 mm or less, for example; however, they are not limited thereto.

The first transverse slit 170 straddles the first minor groove 110 and second minor groove 120 of the central minor grooves 101, traverses the central land 100, and communicates with the outside central main groove 600 and the inside central main groove 700. In other words, the outside central main groove 600 and the inside central main groove 700 are in communication via the first transverse slit 170. The first transverse slit 170 of the embodiment is substantially parallel with the first sloped groove 130 and the first sipe 150. In addition, the width of the first transverse slit 170 is larger than both the width of the first minor groove 110 and the width of the second minor groove 120.

As shown in FIGS. 1 and 2, the central land 100 includes a plurality of the second sipes 180 in communication with the outside central main groove 600. Each of the plurality of second sipes 180 is substantially parallel to the first sloped groove 130 and the first sipe 150, and provided in a form extending on an extension of each first sloped groove 130. Therefore, the plurality of second sipes 180 are arranged in the tire-circumferential direction at the same pitch as the plurality of first sloped grooves 130. The second sipe 180 has one end on the outer side in the vehicle-width direction communicating with the outside central main groove 600, and the other end on the inner side in the vehicle-width direction terminates without reaching the first sloped groove 130.

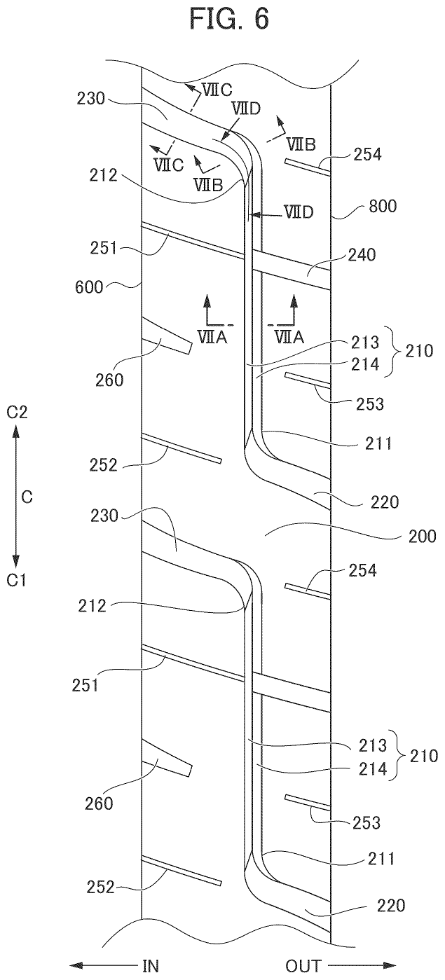

FIG. 6 is an enlarged view of the portion indicated by VI in FIG. 1, and shows a part of the outside intermediate land 200. As shown in FIGS. 1 and 6, the outside intermediate land 200 includes, in the surface thereof, a plurality of third minor grooves 210 extending linearly along the tire-circumferential direction. The plurality of third minor grooves 210 are arranged at intervals in the tire-circumferential direction. The width of the third minor grooves 210 is on the order of 1.6 mm or more and 4 mm or less, for example, and the depth is on the order of 1 mm or more and 5 mm or less, for example; however, they are not limited thereto.

As shown in FIG. 6, the third minor groove 210 includes one end 211 at a tire-circumferential direction one side C1 and one other end 212 at a tire-circumferential direction other side C2. The one end 211 and the other end 212 are both ends of the linear third minor groove 210. The third minor groove 210 is arranged offset somewhat to the outer side in the vehicle-width direction (right side in FIGS. 1 and 6) than the center in the width direction of the outside intermediate land 200.

The outside intermediate land 200 includes a second sloped groove 220 and a third sloped groove 230. Each of the second sloped groove 220 and the third sloped groove 230 is an example of the second slit of the present disclosure, substantially parallel to the first slit 7 described later, extending in a direction intersecting the tire-circumferential direction C, and having one end thereof existing within the land. The widths of the second sloped groove 220 and the third sloped groove 230 are on the order of 2 mm or more and 6 mm or less, for example, and the depths are on the order of 6 mm or more and 12 mm or less, for example; however, they are not limited thereto.

The second sloped groove 220 extends from the one end 211 of the third minor groove 210 to the side of the outside shoulder main groove 800, and communicates with the outside shoulder main groove 800. The second sloped groove 220 is configured so as to form an obtuse angle (91 degrees or more) with the one end 211 of the third minor groove 210, and slopes to the tire-circumferential direction one side C1.

The third sloped groove 230 extends from the other end 212 of the third minor groove 210 to the side of the outside central main groove 600, and communicates with the outside central main groove 600. The third sloped groove 230 is configured so as to form an obtuse angle (91 degrees or more) with the other end 212 of the third minor groove 210, and slopes to the tire-circumferential direction other side C2.

The second sloped groove 220 and the third sloped groove 230 are substantially parallel with the first sloped groove 130. A continuous groove of a shape that can be considered a substantially Z shape or crank shape is formed by the third minor groove 210, the second sloped groove 220 and the third sloped groove 230.

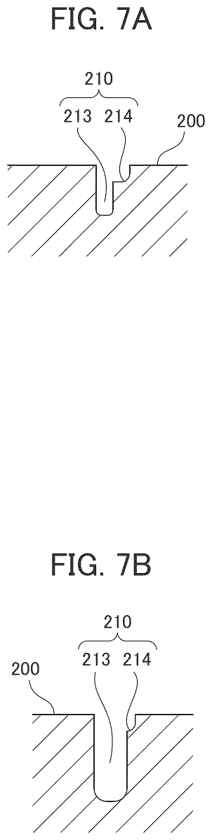

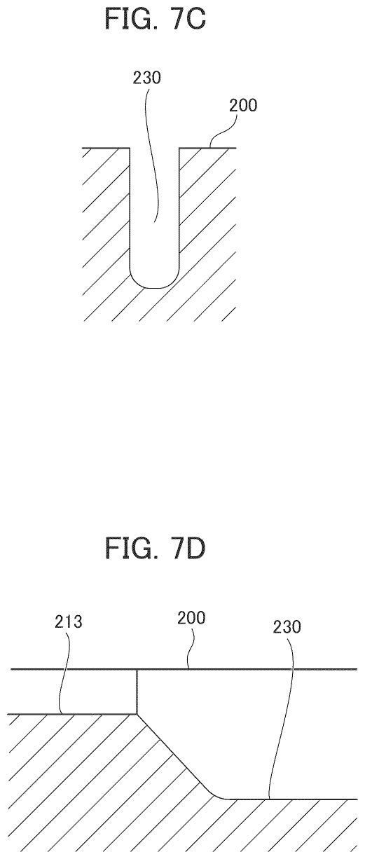

FIG. 7A is a cross-sectional view along VIIA-VIIA in FIG. 6. FIG. 7B is a cross-sectional view along VIIB-VIIB in FIG. 6. FIG. 7C is a cross-sectional view along VIIC-VIIC in FIG. 6. FIG. 7D is a cross-sectional view along VIID-VIID in FIG. 6.

As shown in FIGS. 6 and 7A, the third minor groove 210 includes a second narrow groove 213, and a second shelf 214 provided on one side of the second narrow groove 213 (in this case, outer side in vehicle-width direction). The second narrow groove 213 is a groove having a similar width as each of the sipes described later. The second shelf 214 is shallower than the second narrow groove 213, and has the form of a stepped shape communicating with the second narrow groove 213. The width of the second shelf 214 has a dimension on the same order as the width of the second narrow groove 213; however, it is not limited thereto.

As shown in FIGS. 6 and 7B, in a portion from the third minor groove 210 toward the third sloped groove 230, the width and depth of the second narrow groove 213 gradually become larger, and the width of the second shelf 214 gradually becomes smaller. As shown in FIG. 6, the second shelf 214 has a tapered shape as approaching the third sloped groove 230 from the third minor groove 210, and disappears when reaching the third sloped groove 230. The width of the second narrow groove 213 becomes larger accompanying the disappearance of the second shelf 214, and eventually the second narrow groove 213 leads into the third sloped groove 230 and disappears. FIG. 7C shows a cross section of the third sloped groove 230. As shown in FIG. 7C, the third sloped groove 230 has a larger width and depth than the second narrow groove 213.

FIG. 7D shows a cross section in the groove length direction of a portion from the third minor groove 210 toward the third sloped groove 230. As shown in FIG. 7D, in the portion from the third minor groove 210 toward the third sloped groove 230, the depth of the second narrow groove 213 gradually becomes larger. Then, the second narrow groove 213 becomes the depth of the third sloped groove 230 and disappears accompanying the disappearance of the second shelf 214.

A portion from the third minor groove 210 toward the second sloped groove 220 is also similar to as described above.

The outside intermediate land 200 includes a plurality of first intermediate slits 240. One of the first intermediate slit 240 is provided for one third minor grooves 210. The width of the first intermediate slit 240 is on the order for 1.8 mm or more and 5 mm or less, for example, and the depth is on the order of 5 mm or more and 11 mm or less, for example; however, they are not limited thereto.

The first intermediate slit 240 extends to the outer side in the vehicle-width direction with a starting point of the middle of the length direction of the third minor groove 210, and communicates with the outside shoulder main groove 800. This starting point of the first intermediate slit 240 is at a position somewhat biased more to the side of the tire-circumferential direction other side C2 than the center in the length direction of the third minor groove 210. The first intermediate slit 240 slopes relative to the tire-circumferential direction so as to make an angle nearly parallel to the second sloped groove 220.

As shown in FIG. 6, the outside intermediate land 200 includes a plurality of third sipes 251, a plurality of fourth sipes 252, a plurality of fifth sipes 253 and a plurality of sixth sipes 254. These sipes 251 to 254 are each arranged at intervals in the tire-circumferential direction.

The third sipes 251 extend to the inner side in the vehicle-width direction with the starting point from the third minor groove 210 of the first intermediate slit 240 as a shared starting point, and communicates with the outside central main groove 600. The third sipe 251 slightly curves so as to be convex to the tire-circumferential direction one side C1. The third sipe 251 slopes relative to the tire-circumferential direction, so as to be substantially parallel with the second sloped groove 220 and the third sloped groove 230. The third sipe 251 extends along substantially an extension of the first intermediate slit 240.

The fourth sipe 252 is arranged on the inner side in the vehicle-width direction of the second sloped groove 220. The fourth sipe 252 extends along substantially an extension of the second sloped groove 220. The fourth sipe 252 is between a pair of adjacent third sipes 251 in the tire-circumferential direction, and arranged at substantially the center therebetween. The fourth sipe 252 is substantially parallel with the third sipe 251, and slopes relative to the tire-circumferential direction. The fourth sipe 252 has one end on the inner side in the vehicle-width direction in communication with the outside central main groove 600, and the other end on the outer side in the vehicle-width direction terminates without reaching the second sloped groove 220.

The fifth sipe 253 is arranged on the outer side in the vehicle-width direction of the third minor groove 210. The fifth sipe 253 is between the second sloped groove 220 and the first intermediate slit 240 in the tire-circumferential direction C, and is arranged at substantially the center therebetween. The fifth sipe 253 is substantially parallel to the third sipe 251, and slopes to the tire-circumferential direction. The fifth sipe 253 has one end on the outer side in the vehicle-width direction in communication with the outside shoulder main groove 800, and the other end on the inner side in the vehicle-width direction terminates without reaching the third minor groove 210.

The sixth sipe 254 is arranged on the outer side in the vehicle-width direction of the third sloped groove 230. The sixth sipe 254 extends along substantially an extension of the third sloped groove 230. The sixth sipe 254 is between a pair of adjacent fifth sipes 253 in the tire-circumferential direction, and is arranged at substantially the center therebetween. The sixth sipe 254 is substantially parallel to the fifth sipe 253, and slopes relative to the tire-circumferential direction. The sixth sipe 254 has one end on the outer side in the vehicle-width direction in communication with the outside shoulder main groove 800, and the other end on the inner side in the vehicle-width direction terminates without reaching the third sloped groove 230.

As shown in FIG. 6, the outside intermediate land 200 further includes a plurality of second intermediate slits 260 arranged at intervals in the tire-circumferential direction C. The second intermediate slit 260 is arranged at the inner side in the vehicle-width direction of the third minor groove 210. The second intermediate slit 260 extends along substantially an extension of the fifth sipe 253. The second intermediate slit 260 is between the third sipe 251 and the fourth sipe 252 in the tire-circumferential direction C, and arranged at substantially the center therebetween. The second intermediate slit 260 is substantially parallel to the first intermediate slit 240, and slopes to the tire-circumferential direction C. The second intermediate slit 260 has one end on the inner side in the vehicle-width direction in communication with the outside central main groove 600, and the other end on the outer side in the vehicle-width direction terminates without reaching the third minor groove 210. In the second intermediate slit 260, the width thereof gradually becomes larger, and the depth thereof gradually becomes larger as approaching an opening side to the outside central main groove 600 from the terminal end side.

The width of the second intermediate slit 260 is on the order of 0.8 mm or more and 3 mm or less at the terminal end position having the smallest width, and is on the order of 2 mm or more and 5 mm or less at the opening position to the outside central main groove 600 having the largest width. The depth of the second intermediate slit 260 is on the order of 1 mm or more and 3 mm or less at the terminal end position having the shallowest width, and on the order of 3 mm or more and 6 mm or less at the opening position to the outside central main groove 600 having the deepest width; however, it is not limited thereto.

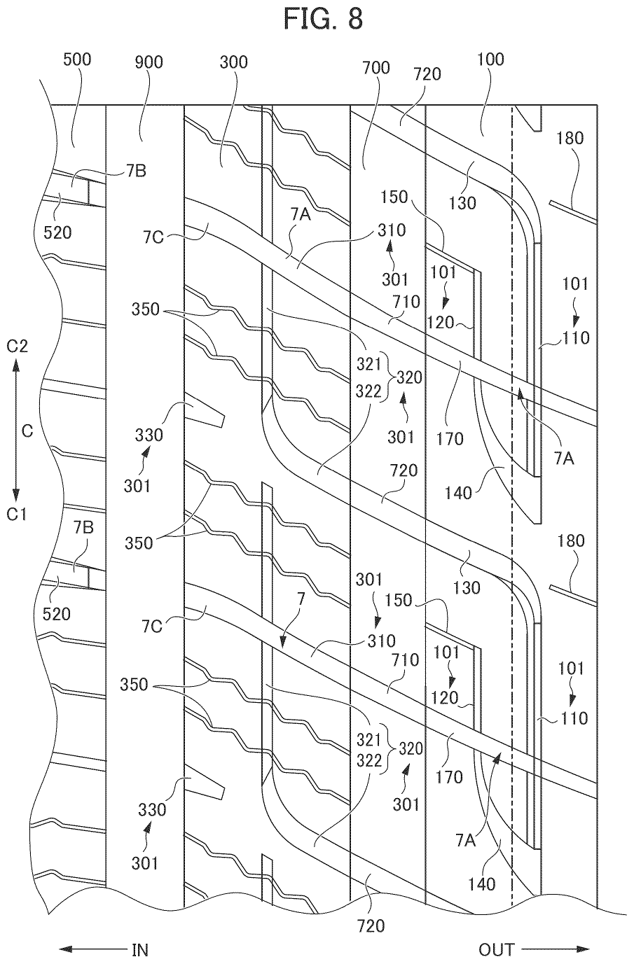

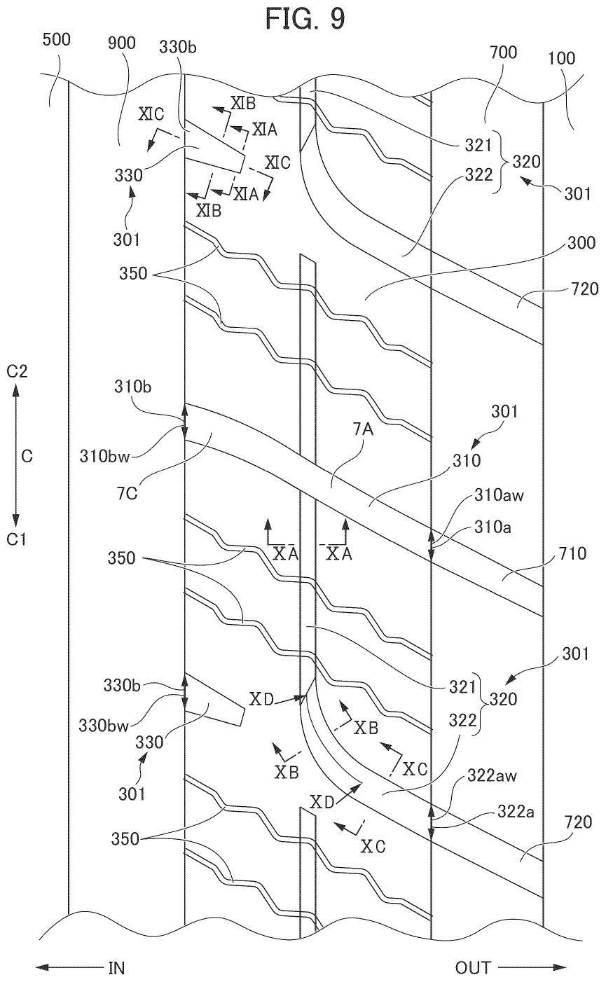

FIG. 8 is an enlarged view of the portion indicated by VIII in FIG. 1. FIG. 9 is an enlarged view of the portion indicated by IX in FIG. 1.

As shown in FIGS. 8 and 9, the inside intermediate land 300 includes a plurality of inside intermediate slits 301.

The inside intermediate slit 301 includes a plurality of second transverse slits 310, a plurality of bent slits 320 and a plurality of third intermediate slits 330. Each of these slits 310, 320, 330 is arranged at an interval in the tire-circumferential direction C.

The second transverse slit 310 traverses the inside intermediate land 300, and communicates with the inside central main groove 700 and the inside shoulder main groove 900. The second transverse slit 310 extends over an extension of the first transverse slit 170 of the central land 100, and slopes to the tire-circumferential direction C in a form substantially parallel with the first transverse slit 170. The width of the second transverse slit 310 is on the order of 2 mm or more and 6 mm or less, for example, and the depth is on the order of 6 mm or more and 12 mm or less, for example; however, they are not limited thereto.

As shown in FIG. 9, the second transverse slit 310 includes a first opening 310a which opens to the inside central main groove 700, and a second opening 310b which opens to the inside shoulder main groove 900. In the second transverse slit 310, the width gradually becomes larger as approaching the second opening 310b from the first opening 310a.

The bent slit 320 is formed in a bent shape from the inside central main groove 700 to the second transverse slit 310, and communicates the inside central main groove 700 and the second transverse slit 310. The bent slit 320 of the embodiment includes a linear portion 321 extending linearly along the tire-circumferential direction, and a sloped portion 322 extending from an end of the linear portion 321 on the tire-circumferential direction one side C1 to the side the inside central main groove 700. The linear portion 321 is arranged at substantially the center in the width direction of the inside intermediate land 300, and is provided in a form passing through the second transverse slit 310. The length of the linear portion 321 of the bent slit 320 in the tire-circumferential direction C is longer than the length of the third minor groove 210 of the outside intermediate land 200 in the tire-circumferential direction C. The sloped portion 322 includes an opening 322a communicating to the inside central main groove 700. The sloped portion 322 of the bent slit 320 is an example of the second slit of the present disclosure which is substantially parallel with the first slit 7 described later, extends in a direction intersecting the tire-circumferential direction C, and one end thereof existing within the land.

The width of the linear portion 321 is on the order of 1 mm or more and 4 mm or less, for example, and the depth is on the order of 1 mm or more and 4 mm or less, for example; however, they are not limited thereto. The width of the sloped portion 322 is on the order of 2 mm or more and 6 mm or less, for example, and the depth is on the order of 6 mm or more and 12 mm or less, for example; however, they are not limited thereto.

As shown in FIG. 8, the sloped portion 322 extends along an extension line of the first sloped groove 130 of the central land 100, and is substantially parallel with the first sloped groove 130. In other words, the sloped portion 322 intersects with the tire-circumferential direction C, and slopes relative to the tire-circumferential direction C. The bent slit 320 of the embodiment includes a substantially inverted L-shape as a whole.

The inside central main groove 700 includes groove-internal slit 710 provided in a form communicating the second transverse slit 310 of the inside intermediate slit 301 and the first transverse slit 170 of the central land 100, and a projecting strip 720 arranged between the sloped portion 322 of the bent slit 320 and the first sloped groove 130 of the central land 100.

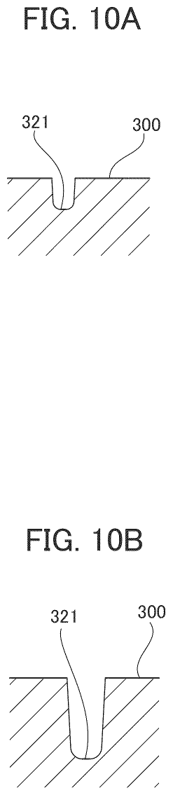

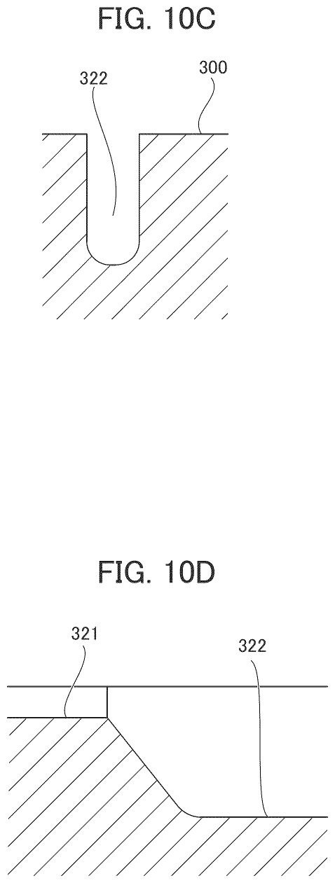

FIG. 10A is a cross-sectional view along XA-XA in FIG. 9. FIG. 10B is a cross-sectional view along XB-XB in FIG. 9. FIG. 10C is a cross-sectional view along XC-XC in FIG. 9. FIG. 10D is a cross-sectional view along XD-XD in FIG. 9, and shows a cross section in a groove-length direction of a portion from the linear portion 321 toward the sloped portion 322.

As shown in these FIGS. 10A to 10D, in the bent slit 320 of the embodiment, the depth of the sloped portion 322 shown in FIG. 10C is deeper than the depth of the linear portion 321 shown in FIG. 10A. In a portion from the linear portion 321 toward the sloped portion 322, the depth gradually becomes larger as approaching the sloped portion 322 from the linear portion 321 as shown in FIGS. 10C and 10D, and the groove bottom is sloped.

The third intermediate slit 330 extends along substantially an extension of the sloped portion 322 of the bent slit 320. The third intermediate slit 330 is substantially parallel with the second transverse slit 310 and the sloped portion 322, and slopes to the tire-circumferential direction C. The third intermediate slit 330 has one end on the inner side in the vehicle-width direction in communication with the inside shoulder main groove 900, and the other end on the outer side in the vehicle-width direction terminates without reaching the bent slit 320. In the third intermediate slit 330, the width thereof gradually becomes larger, and the depth gradually becomes larger, as approaching the opening 330b side to the inside shoulder main groove 900 from the terminal end side.

The width of the third intermediate slit 330 is on the order of 1 mm or more and 3 mm or less at the terminal end position having the smallest width, and is on the order of 2 mm or more and 5 mm or less at the opening position to the outside central main groove 600 having the largest width; however, it is not limited thereto. The depth of the third intermediate slit 330 is on the order of 1 mm or more and 3 mm or less at the terminal end position having the shallowest width, and is on the order of 5 mm or more and 10 mm or less at the opening position to the outside central main groove 600 having the deepest width; however, it is not limited thereto.

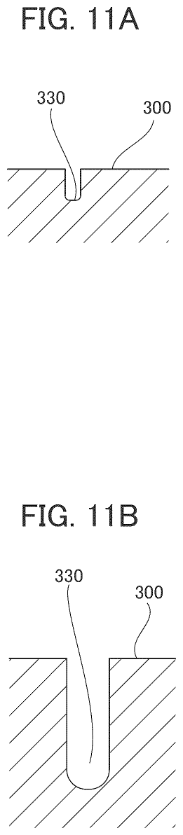

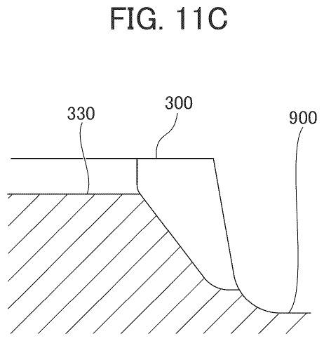

FIG. 11A is a cross-sectional view along XIA-XIA in FIG. 9. FIG. 11B is a cross-sectional view along XIB-XIB in FIG. 9. FIG. 11C is a cross-sectional view along XIC-XIC in FIG. 9.

As shown in FIGS. 11A to 11C, the third intermediate slit 330 is in communication with the inside shoulder main groove 900, while the depth gradually becomes larger as approaching the opening 330b from the terminal end.

Herein, as shown in FIG. 9, in the tire 1 as a whole, the total of the width 310aw of the first openings 310a of the plurality of the second transverse slits 310 and the width 322aw of the openings 322a of the sloped portions 322 of the plurality of bent slits 320 relative to the inside central main groove 700 is defined as “(310aw×n1)+ (322aw×n2)”=W1. In addition, in the tire 1 as a whole, the total of the width 310bw of the second openings 310b of the plurality of second transverse slits 310 and the width 330bw of the openings 330b of the plurality of third intermediate slits 330 relative to the inside shoulder main groove 900 is defined as “(310bw×n1)+ (330bw×n3)”=W2.

n1 is a total number of the plurality of second transverse slits 310 provided in the tread 2, n2 is a total number of the plurality of bent slits 320 provided in the tread 2, and n3 is a total number of the plurality of third intermediate slits 330 provided in the tread 2.

The tire 1 of the embodiment satisfies W1<W2.

As shown in FIGS. 8 and 9, the inside intermediate land 300 further includes a plurality of the intermediate sipes 350.

Two of the plurality of intermediate sipes 350 are arranged between each of the second transverse slits 310 and sloped portions 322 of the bent slit 320 in the tire-circumferential direction C. The intermediate sipe 350 has a wave shape between both short straight ends. The intermediate sipe 350 is substantially parallel with the second transverse slit 310 as a whole. The intermediate sipe 350 intersects the linear portion 321 of the bent slit 320, traverses the inside intermediate land 300, and communicates with the inside central main groove 700 and the inside shoulder main groove 900.

As shown in FIG. 1, the outside shoulder land 400 is arranged between the outside shoulder main groove 800 and the outside sidewall 9A. The end of the outside shoulder land 400 on the outer side in the vehicle-width direction is continuous smoothly with the outside sidewall 9A.

The outside shoulder land 400 includes a plurality of the outside lug grooves 410, a plurality of outside slits 430 and a plurality of outside shoulder sipes 440, respectively arranged at intervals in the tire-circumferential direction.

The outside lug groove 410 extends from an end on an outer side in the tire-radial direction of the outside sidewall 9a towards the outside shoulder main groove 800 in a direction intersecting the tire-circumferential direction C, and terminates without reaching the outside shoulder main groove 800. Then, the outside slit 430 extends from the terminal end of the outside lug groove 410 to the outside shoulder main groove 800, and communicates with the outside shoulder main groove 800.

The outside lug groove 410 slightly slopes to the tire-circumferential direction one side C1 as approaching the outer side from the inner side in the vehicle-width direction, and slightly curves so as be convex to the tire-circumferential direction one side C1. In addition, in the outside lug groove 410, the width gradually becomes larger and the depth gradually becomes smaller as approaching the outer side from the inner side in the vehicle-width direction. The end on the inner side in the vehicle-width direction of the outside lug groove 410 is a tapered shape towards the outside slit 430.

The width of the outside slit 430 is smaller than the width of the outside lug groove 410, and is constant. The outside slit 430 is configured to follow the edge on the tire-circumferential direction other side C2 of the outside lug groove 410, and extends along an extension of the outside lug groove 410.

The width of the outside lug groove 410 becomes larger from on the order of 1 mm or more and 3 mm or less, for example, until on the order of 2 mm and 7 mm or less at the ground end, as approaching an end on the outer side in the vehicle-width direction from the end on the inner side in the vehicle-width direction. The depth of the outside lug groove 410 becomes smaller from 6 mm or more and 10 mm or less until on the order of 0.5 mm or more and 2 mm or less, for example, as approaching the end on the outer side in the vehicle-width direction from the end on the inner side in the vehicle-width direction.

The width of the outside slit 430 is on the order of 1 mm or more and 3 mm or less, for example, and the depth is on the order of 2 mm or more and 5 mm or less, for example; however, they are not limited thereto.

An outside patterned groove 450 extending in the tire-circumferential direction is provided at the outer side in the vehicle-width direction of the outside shoulder land 400. The outside patterned groove 450 passes through the ends on the outer side in the vehicle-width direction of a pair of outside lug grooves 410 adjacent in the tire-circumferential direction.

A pair of the outside shoulder sipes 440 are arranged between a pair of the outside lug grooves 410 adjacent in the tire-circumferential direction. The outside shoulder sipe 440 has one end on the inner side in the vehicle-width direction that communicates with the outside shoulder main groove 800, then extends from one end thereof towards the outer side in the vehicle-width direction in a direction intersecting the tire-circumferential direction, and terminates without reaching the outside patterned groove 450. The outside shoulder sipe 440 slightly slopes to the tire-circumferential direction one side C1 as approaching the outer side from the inner side in the vehicle-width direction, and slightly curves so as to be convex to the tire-circumferential direction one side C1, so as to be substantially parallel with the outside lug groove 410. By a pair of the outside shoulder sipes 440 arranged between a pair of the outside lug grooves 410, the land between this pair of outside lug grooves 410 is divided into three substantially equal portions in the tire-circumferential direction.

As described above, in the outside shoulder sipe 440, a shape at the surface of the tire 1, i.e. surface of the outside shoulder land 400, has a curved shape. This curved shape is a simple curved shape such that draws a single arc from one end communicating with the outside shoulder main groove 800 until the terminal end on the outer side in the vehicle-width direction, and thus a wave shape, zigzag shape, bent shape or the like does not exist from one end to the terminal end. It should be noted that the surface shape of the tire 1 at the outside shoulder sipe 440 may be a linear shape.

The outside shoulder sipe 440 is a simple curved shape at the tire surface as described above; however, it is a 3D sipe having a 3D shape in the depth direction. Herein, 3D sipe refers to a sipe which, in addition to being three-dimensional by bending in the extending direction (length direction from above-mentioned one end to terminal end) of the outside shoulder sipe 440, is three-dimensional having a portion that bends also in the depth direction.

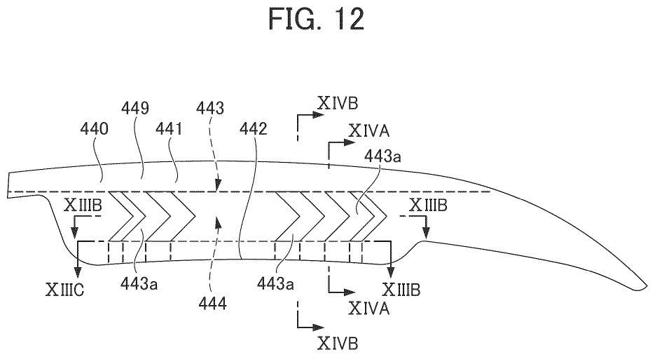

FIG. 12 schematically shows the outside shoulder sipe 440 overall in a state viewed from a lateral surface direction. Lateral surface direction in this case is a direction from the tire-circumferential direction one side C1, and FIG. 12 is an image viewing the inner wall surface overall on the side of the tire-circumferential direction other side C2 of the outside shoulder sipe 440 from this direction.

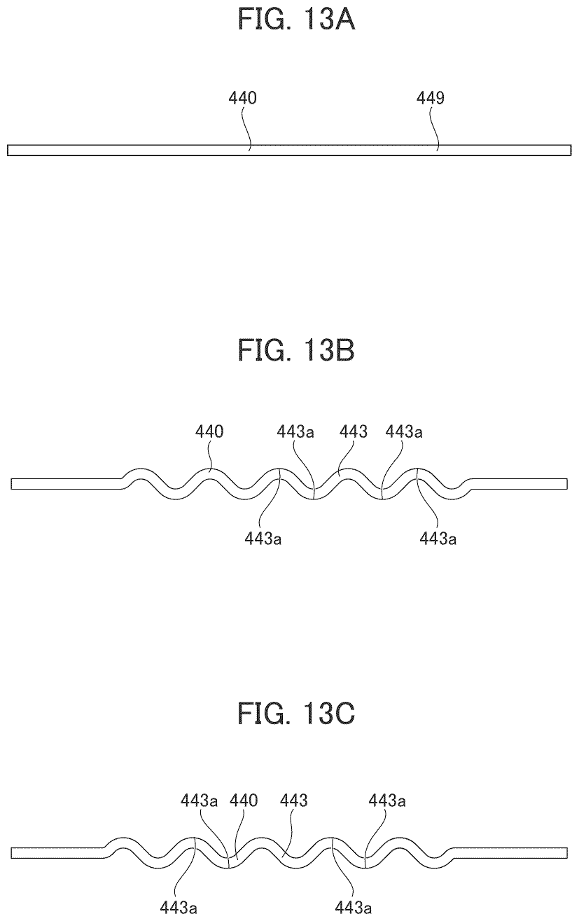

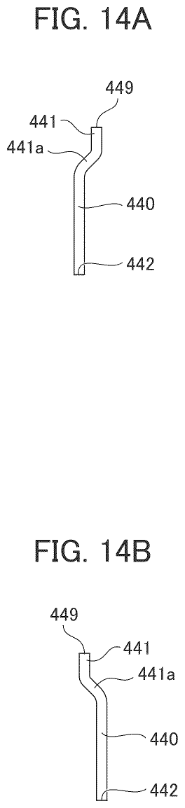

FIG. 13A is a plan view showing an opening 449 of the outside shoulder sipe 440 at the tire surface. FIG. 13B shows a cross section along XIIIB-XIIIB in FIG. 12. FIG. 13C shows a cross section along XIIIC-XIIIC in FIG. 12. FIG. 14A shows a cross section along XIVA-XIVA in FIG. 12. FIG. 14B shows a cross section along XIVB-XIVB in FIG. 12. In FIGS. 13B, 13C, 14A and 14B, only the outside shoulder sipe 440 is shown. As mentioned above, the outside shoulder sipe 440 at the tire surface is a curved shape, and although assuming a form in which this curve shape is reflected in the depth direction as a whole, even if at the tire inside, FIGS. 13A to 13C simplify the shape in the extension direction of the outside shoulder sipe 440, and depict linearly.

As shown in FIG. 12, in the outside shoulder sipe 440, the outer layer portion 441 from the surface of the outside shoulder land 400 until a predetermined depth forms a linear groove, without a shape change in the extension direction and depth direction. Then, in a predetermined portion excluding both sides in the extension direction, a wave-shaped portion 443 formed in a cross-sectional wave shape along the extension direction is provided from the outer layer portion 441 to a bottom portion 442. Furthermore, the outside shoulder sipe 440 includes a bent portion 444 in which the wave shape bends, in a substantially central portion in the depth direction of the wave-shaped portion 443. The bent portion 444 includes a 3D sipe.

As shown in FIGS. 13B and 13C, in the wave-shaped portion 443, a plurality of valley portions 443a extending in the depth direction are alternately formed at one side and the other side of the groove width, along the extension direction of the outside shoulder sipe 440. The period and amplitude of the wave-shaped portion 443 formed by the plurality of valley portions 443a are both constant.

The plurality of valley portions 443a of the wave-shaped portion 443 bend in a chevron shape in the bent portion 444 in the depth direction when viewing from the tire-circumferential direction, as shown in FIG. 12. Therefore, as shown in FIGS. 13B and 13C, in the bent portion 444, the phase of the wave shape in the depth direction becomes shifted. In addition, as shown in FIGS. 14A and 14B, the outer layer portion 441 of the outside shoulder sipe 440 includes a sloped portion 441a which slopes in the tire-circumferential direction from the surface until reaching the bent portion 444. The sloping directions of the sloped portions 441a alternate at one side and the other side of the groove width.

As shown in FIG. 1, the inside shoulder land 500 is arranged between the inside shoulder main groove 900 and the inside sidewall 9B. The end on the inner side in the vehicle-width direction of the inside shoulder land 500 is smoothly continuous with the inside sidewall 9B.

The inside shoulder land 500 includes a plurality of first inside lug grooves 510, a plurality of second inside lug grooves 520, a plurality of inside slits 530 and a plurality of inside shoulder sipes 540 respectively arranged at intervals in the tire-circumferential direction.

The first inside lug grooves 510 and the second inside lug grooves 520 are arranged alternately at intervals in the tire-circumferential direction.

The first inside lug groove 510 extends from an end on the outer side in the tire-radial direction of the inside sidewall 9B toward the inside shoulder main groove 900 in a direction intersecting the tire-circumferential direction, and terminates without reaching the inside shoulder main groove 900. Then, from the terminal end of this first inside lug groove 510, the inside slit 530 extends until the inside shoulder main groove 900, and communicates with the inside shoulder main groove 900.

The first inside lug groove 510 slightly slopes to the tire-circumferential direction other side C2 as approaching the inner side from the outer side in the vehicle-width direction, and slightly curves so as be convex to the tire-circumferential direction other side C2. The width of the first inside lug groove 510 is substantially constant; however, the end on the outer side in the vehicle-width direction is a tapered shape towards the inside slit 530.

The width of the inside slit 530 is smaller than the width of the first inside lug groove 510, and is constant. The inside slit 530 is configured to approximately follow the center line of the width of the first inside lug groove 510, and extends along an extension of the first inside lug groove 510.

The second inside lug groove 520 is a form almost identical to the first inside lug groove 510, and is parallel to the first inside lug groove 510, but is in communication with the inside shoulder main groove 900. The second inside lug groove 520 slightly slopes to the tire-circumferential direction other side C2 as approaching the inner side in the vehicle-width direction, from one end on the outer side in the vehicle-width direction communicating with the inside shoulder main groove 900, and slightly curves so as to be convex to the tire-circumferential direction other side C2. Although the width of the second inside lug groove 520 is substantially constant, the depth becomes gradually smaller as approaching the inner side from the outer side in the vehicle-width direction. At the end on the outer side in the vehicle-width direction of the second inside lug groove 520, the width becomes gradually narrower as approaching the inside shoulder main groove 900.

The width of the first inside lug groove 510 is on the order of 2 mm or more and 7 mm or less at the ground end, for example; however, it is not limited thereto. The depth of the first inside lug groove 510 becomes larger from on the order of 0.5 mm or more and 2 mm or less until 6 mm or more and 10 mm or less, as approaching the end on the inner side in the vehicle-width direction from the end on the outer side in the vehicle-width direction, for example.

The width of the inside slit 530 is on the order of 1 mm or more and 3 mm or less, for example, and the depth is on the order of 2 mm or more and 5 mm or less, for example; however, they are not limited thereto.

At the inner side in the vehicle-width direction of the inside shoulder land 500, the inside patterned groove 550 extending in the tire-circumferential direction is provided. The inside patterned groove 550 extends substantially in the tire-circumferential direction over the ends on the inner side in the vehicle-width direction of a pair of second inside lug grooves 520 adjacent in the tire-circumferential direction. The inside patterned groove 550 passes through the first inside lug groove 510 between this pair of second inside lug grooves 520.

A pair of inside shoulder sipes 540 are arranged between a first inside lug groove 510 and a second inside lug groove 520 adjacent in the tire-circumferential direction. The inside shoulder sipe 540 has one end on the outer side in the vehicle-width direction in communication with the inside shoulder main groove 900, extends from this one end to the inner side in the vehicle-width direction in a direction intersecting the tire-circumferential direction, and terminates without reaching the inside patterned groove 550. The inside shoulder sipe 540 slightly slopes to the tire-circumferential direction other side C2 as approaching the inner side from the outer side in the vehicle-width direction, so as to be substantially parallel to the first inside lug groove 510 and the second inside lug groove 520, and slightly curves as a whole so as to be convex to the tire-circumferential direction other side C2. The land between the first inside lug groove 510 and the second inside lug groove 520 is divided into three substantially equal portions in the tire-circumferential direction, by the pair of inside shoulder sipes 540 arranged between the first inside lug groove 510 and the second inside lug groove 520.

As described above, in the inside shoulder sipe 540, the shape of an opening in the surface of the tire 1, i.e. surface of the inside shoulder land 500, has a curved shape as a whole; however, as shown in FIG. 1, a part thereof includes a wave-shaped portion in which wave-shaped valleys are alternately continuous in the extending direction of the inside shoulder sipe 540. In other words, as shown in FIG. 1, the inside shoulder sipe 540 includes a wave-shaped portion 543, an inside extension portion 547 extending substantially linearly to the inner side in the vehicle-width direction continuous with the wave-shaped portion 543, and a sipe bridge 548 extending substantially linearly to the outer side in the vehicle-width direction continuous with the wave-shaped portion 543, and communicating with the inside shoulder main groove 900. The depth of the wave-shaped portion 543 is on the order of 5 mm or more and 9 mm or less, for example; however, it is not limited thereto. The depth of the sipe bridge 548 is on the order of 1.5 mm or more and 4.0 mm or less, for example; however, it is not limited thereto.

The inside shoulder sipe 540 includes a 3D sipe having a 3D shape in the depth direction, similarly to the outside shoulder sipe 440.

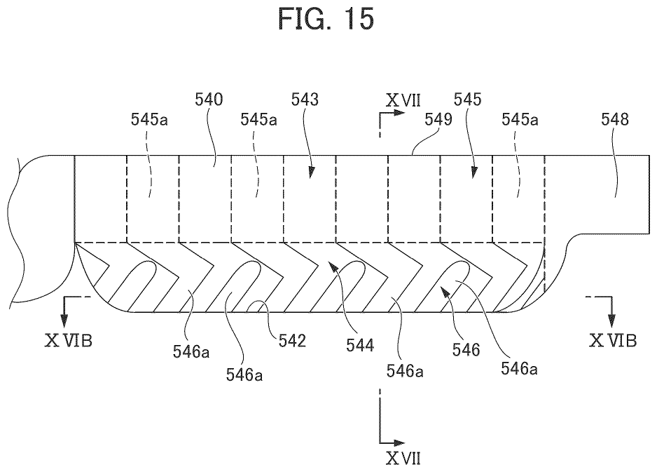

FIG. 15 schematically shows the wave-shaped portion 543 of the inside shoulder sipe 540 and a portion of the sipe bridge 548 in a state viewed from the lateral surface direction. Lateral surface direction in this case is a direction from the tire-circumferential direction one side C1, and FIG. 15 is an image viewing from this direction the inner wall surface overall of the inside shoulder sipe 540 on the side of the tire-circumferential direction other side C2.

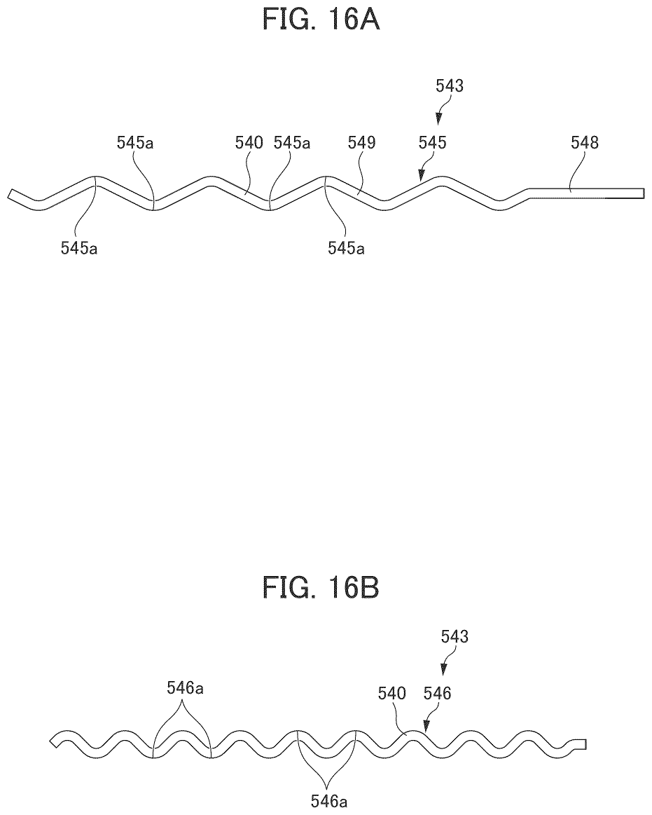

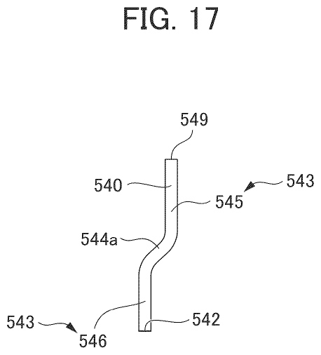

FIG. 16A is a plan view showing the wave-shaped portion 543 of the inside shoulder sipe 540 and an opening 549 of the sipe bridge 548 at the tire surface. In the inside shoulder sipe 540, the shape of the opening 549 of the tire surface includes a wave shape. FIG. 16B shows the XVIB-XVI cross section in FIG. 15. FIG. 17 shows the XVII-XVII cross section in FIG. 15. FIGS. 16B and 17 show only the inside shoulder sipe 540. FIGS. 16A and 16B simplify the shape in the extension direction and shows linearly, similarly to the outside shoulder sipe 440 shown in FIGS. 13A to 13C.

The wave-shaped portion 543 of the inside shoulder sipe 540 is formed with a cross-sectional wave shape along the extension direction spanning from the opening 549 to the bottom portion 542. The wave-shaped portion 543 includes a bent portion 544 more towards the bottom portion 542 than a substantially central portion in the depth direction thereof. The bent portion 544 includes a 3D sipe.

As shown in FIG. 15, the wave-shaped portion 543 includes a first periodic portion 545 adjacent to the opening 549, and a second periodic portion 546 adjacent to the bottom portion 542, with substantially the center in the depth direction as a border. Wave shape of the first periodic portion 545 and wave shape of the second periodic portion 546 have nearly identical amplitudes; however, the period thereof is shorter for the second periodic portion 546 than the first periodic portion 545. For example, the period of the second periodic portion 546 is about ½ the period of the first periodic portion 545. In other words, in the wave-shaped portion 543 of the inside shoulder sipe 540, the period of the wave shape changes to be shorter in the depth direction.

The first periodic portion 545 includes a plurality of valley portions 545a extending from the opening 549 in the depth direction. The plurality of valley portions 545a are alternately formed at one side and the other side of the groove width, along the extension direction of the wave-shaped portion 543. The plurality of valley portions 545a bend to one side (for example, inner side in vehicle-width direction) of the extending direction of the first periodic portion 545, when reaching the bent portion 544.

The second periodic portion 546 includes a plurality of valley portions 546a extending from the bottom portion 542 to the direction of the opening 549. The plurality of valley portions 546a are alternately formed at the one side and other side of the groove width along the extension direction of the wave-shaped portion 543. The plurality of valley portions 546a bend to the other side (for example, outer side in vehicle-width direction) in the extension direction of the second periodic portion 546, when reaching the bent portion 544. The width of the valley portion 546a is about ½ of the width of the valley portion 545a of the first periodic portion 545. This is due to the period of the second periodic portions 546 being about ½ the period of the first periodic portions 545.

In the bent portion 544, due to the valley portions 545a of the first periodic portion 545 and the valley portions 546a of the second periodic portion 546, it bends in a chevron shape when viewing from the tire-circumferential direction. In other words, at the bent portion 544 of the inside shoulder sipe 540, the period of the wave shape changes from the large period of the first periodic portion 545 to the short period of about ½ in the short second periodic portion 546.

As shown in FIG. 17, the bent portion 544 includes a sloped portion 544a sloping to one side of the groove width in the depth direction.

Herein, in the embodiment, the depth of the outside shoulder sipe 440 of the outside shoulder land 400 and the depth of the inside shoulder sipe 540 of the inside shoulder land 500 preferably have the following relationship. More specifically, the sipe length of the outside shoulder sipe 440 at 50% depth relative to the depth of each main groove preferably approximates the sipe length of the inside shoulder sipe 540 at 50% depth relative to the depth of each main groove, for example, may approximate within the range of +/−10%. The sipe length referenced herein indicates the overall length in the extending direction of the sipe, of the wave shape in the cross section.

As shown in FIG. 1, the aforementioned second intermediate slit 260, first transverse slit 170, groove-internal slit 710, second transverse slit 310, and second inside lug groove 520 are provided in a continuous form while sloping to the tire-circumferential direction other side C2 as approaching the outer side from the inner side in the vehicle-width direction. Herein, this second intermediate slit 260, first transverse slit 170, groove-internal slit 710, second transverse slit 310 and second inside lug groove 520 are collectively referred and called a first slit 7. This first slit 7 is formed in a continuously extending state from the outside intermediate land 200 spanning the central land 100, inside intermediate land 300 and inside shoulder land 500.

The first slit 7 extends substantially in parallel with each of the aforementioned first sloped groove 130, second sloped groove 220, third sloped groove 230 and sloped portion 322 of the bent slit 320.

The first slit 7 includes a first curved portion 7A within a range from the outside intermediate land 200 through the central land 100 to a middle of the inside intermediate land 300 that curves convexly to the tire-circumferential direction one side C1. The first curved portion 7A curves so as to return to the tire-circumferential direction other side C2 as approaching the outer side from the inner side of the vehicle-width direction. In the embodiment, this first curved portion 7A extends from the outside intermediate land 200 to a position more to the side of the inside shoulder main groove 900 than the linear portion 321 of the bent slit 320 in the inside intermediate land 300.

Furthermore, the first slit 7 includes a second curved portion 7b within a range from the middle of the inside intermediate land 300 to the inside shoulder land 500 that curves convexly to the opposite side than the first curved portion 7A, i.e. tire-circumferential direction other side C2. The second curved portion 7B curves so as to return to the side of the tire-circumferential direction one side C1, as approaching the outer side from the inner side of the vehicle-width direction. In the embodiment, this second curved portion 7B extends from a position more to a side of the inside shoulder main groove 900 than the linear portion 321 of the bent slit 320 in the inside intermediate land 300 so as to include a second inside lug groove 520.

As shown in FIG. 8, the first curved portion 7A and the second curved portion 7B are formed continuously via an inflection point 7C. This inflection point 7C is located in the middle in the width direction of the inside intermediate land 300, between the linear portion 321 of the bent slit 320 and the inside shoulder main groove 900.

It should be noted that, in the embodiment, the inside central main groove 700 includes a groove-internal slit 710; however, this portion may be the same depth as the inside central main groove 700 without providing this groove-internal slit 710. In addition, a projecting strip may be formed in place of the groove-internal slit 710. In addition, the inside central main groove 700 includes a projecting strip 720; however, this portion may be the same depth as the inside central main groove 700 without providing this projecting strip 720. In addition, a slit may be formed in place of the projecting strip 720.

The tire 1 of the embodiment is equipped with the above configuration. According to this tire 1, the following effects are exerted.
(1) A tire 1 according to the embodiment includes a tread 2 including a plurality of lands 5 extending in a tire-circumferential direction C and aligned in a tire-axial direction X, a plurality of main grooves 6 provided between a plurality of the lands 5, and a slit provided in the land 5, in which the plurality of the lands 5 includes a central land 100, an outside intermediate land 200 on a tire-axial direction one side of the central land 100, an inside intermediate land 300 on a tire-axial direction other side of the central land 100, an outside shoulder land 400 on the tire-axial direction one side of the outside intermediate land 200 and an inside shoulder land 500 on the tire-axial direction other side of the inside intermediate land 300, in which the plurality of main grooves 6 includes an outside central main groove 600 between the central land 100 and the outside intermediate land 200, an inside central main groove 700 between the central land 100 and the inside intermediate land 300, an outside shoulder main groove 800 between the inside intermediate land 300 and the outside shoulder land 400, and an inside shoulder main groove 900 between the inside intermediate land 300 and the inside shoulder land 500, in which the slit includes a first slit 7 forming a state continuously extending from the outside intermediate land 200 spanning the central land 100, the inside intermediate land 300 and the inside shoulder land 500, the first slit 7 includes a first curved portion 7A within a range from the outside intermediate land 200 through the central land 100 to a middle of the inside intermediate land 300 that curves to the tire-circumferential direction other side C2, and includes a second curved portion 7B within a range from a middle of the inside intermediate land 300 to the inside shoulder land 500 that curves to the opposite side than the first curved portion 7A in the tire-circumferential direction C, i.e. tire-circumferential direction other side C2.

According to the tire 1 of the embodiment, due to the second intermediate slit 260, the first transverse slit 170 and the second transverse slit 310 which constitute the first slit 7, and the second inside lug groove 520, a draining property is ensured in each land 5 in which these slits and lug groove are formed. The drainage is guided in the order of the second intermediate slit 260, the first transverse slit 170, the groove-internal slit 710, the second transverse slit 310 and the second inside lug groove 520; however, these are smoothly drained due to extending continuously, and thus the drainage property is ensured.

Due to the first curved portion 7A of the first slit 7, drainage from the vicinity of the center in the tire-axial direction towards the inside intermediate land 300 during tire ground contact becomes smooth, and thus an improvement in the drainage property is achieved. Then, due to the direction of drainage being changed at the second curved portion 7B having a curving direction to the opposite side than the first curved portion 7A, drainage is guided to a tire side (vehicle-width direction inner side in the embodiment), and thus an improvement in the drainage property is achieved.
(2) In the tire 1 of the above (1) according to the embodiment, the first sloped groove 130 of the central land 100, the second sloped groove 220 and the third sloped groove 230 of the outside intermediate land 200 and the sloped portion 322 of the bent slit 320 of the inside intermediate land 300 are provided as second slits. This second slit is substantially parallel to the first slit 7 and extends in a direction intersecting the tire-circumferential direction C, and one end thereof exists within the land 5.

Thereby, in each land 5 in which the second slit is provided, by the one end of this second slit existing within the land 5, the rigidity of the land 5 is ensured compared to a case of this one end directly communicating with the main groove 6. Due to the rigidity of the land 5 being ensured, an improvement in steering stability is achieved. Since the second slit is substantially parallel to the first slit 7, a decline in the rigidity of the land 5 is suppressed, whereby an improvement in road holding is achieved.
(3) In the tire 1 of the above (1) or (2) according to the embodiment, the first curved portion 7A and the second curved portion 7B are formed continuously via the inflection point 7C, the inflection point 7C existing in a middle of the inside intermediate land 300.

Thereby, for the drainage flowing in the first slit 7, by the direction of drainage being changed from the inside intermediate land 300 at the second curved portion 7B via the inflection point 7C, the drainage is guided to the inner side in the vehicle-width direction, whereby an improvement in the drainage property is achieved.

It should be noted that the present invention is not limited to the above embodiment, and even if modifications, improvements, etc. are made within a scope that can achieve the object of the present invention, they will be encompassed in the scope of the present invention. The present invention includes the combinations of the below <A>.

### <A>

<A-1> A pneumatic tire includes a tread including a plurality of lands extending in a tire-circumferential direction, and aligned in a tire-axial direction; a plurality of main grooves provided between a plurality of the lands, and a slit provided in the land, the plurality of the lands including a central land, a first intermediate land on a tire-axial direction one side of the central land, and a second intermediate land on a tire-axial direction other side of the central land,
a first shoulder land on a tire-axial direction one side of the first intermediate land, and
a second shoulder land on a tire-axial direction other side of the second intermediate land
the plurality of the main grooves includes
a first central main groove between the central land and the first intermediate land,
a second central main groove between the central land and the second intermediate land,
a first shoulder main groove between the first intermediate land and the first shoulder land, and
a second shoulder main groove between the second intermediate land and the second shoulder land,
the slit includes a first slit formed in a state continuously extending from the first intermediate land and spanning the central land, the second intermediate land and the second shoulder land, and
the first slit includes a first curved portion that curves to either side in a tire-circumferential direction within a range from the first intermediate land through the central land to a middle of the second intermediate land, and includes a second curved portion that curves to an opposite side than the first curved portion in the tire-circumferential direction within a range from a middle of the second intermediate land to the second shoulder land.
<A-2> In the pneumatic tire as described in <A-1>, the slit includes a second slit that is provided in at least one among the central land, the first intermediate land and the second intermediate land, is substantially parallel to the first slit and extends in a direction intersecting the tire-circumferential direction, and having one end thereof that extends within the land.
<A-3> In the pneumatic tire as described in <A-1> or <A-2>, the first curved portion and the second curved portion are formed continuously via an inflection point, the inflection point existing in a middle of the second intermediate land.

Furthermore, the present invention includes the pneumatic tire as described in the following <B> to <G>.

### <B>

In a pneumatic tire, grooves extending in the tire-circumferential direction formed in lands contribute to securing gripping force during vehicle turning (during cornering) when traveling on a snowy road, i.e. snow traction. On other hand, when one end of the groove terminates and closes within a land as in the above-mentioned sloped groove, it is difficult for air to escape from within the groove during tire ground contact, and the air may vibrate within the groove to generate noise called air-column resonance sound. Since this sound is useless as tire noise, there is room for improvement. Therefore, the present invention has an object of providing a pneumatic tire capable of obtaining both securing of snow traction and suppression of air-column resonance sound. The pneumatic tire according to <B> includes the following combinations.
<B-1> A pneumatic tire includes a tread including at least one land extending in the tire-circumferential direction and a first main groove and a second main groove as a pair of main grooves on both sides in the tire-axial direction of this land, and minor grooves formed in the land, in which
the minor grooves include
a first minor groove adjacent to the first main groove and extending in the tire-circumferential direction, and having one end at a tire-circumferential direction one side and one other end at a tire-circumferential direction other side, and
a second minor groove adjacent to the first minor groove at a side of the second major groove in the tire-axial direction and extending in the tire-circumferential direction, and having one end at a tire-circumferential direction one side and one other end at a tire-circumferential direction other side,
the one end of the first minor groove and the one end of the second minor groove are connected by a connection groove, and
the other end of the first minor groove communicates with the second main groove via a communication groove. It should be noted that the outside central main groove 600 of the above-mentioned embodiment is an example of the first main groove in <B-1>, and is the first central main groove in <G10> described later. The inside central main groove 700 of the above-mentioned embodiment is an example of the second main groove in <B-1>, and is the second central main groove in <G10> described later. The central minor groove 101 of the above-mentioned embodiment is an example of the minor groove in <B-1>. The first sloped groove 130 of the above-mentioned embodiment is an example of the communication groove in <B-1>.
<B-2> In the pneumatic tire as described in <B-1>, the land includes an enclosed region that is surrounded by at least the connection groove among the first minor groove, the second minor groove and the connection groove, and assumes a tapered shape at a tire-circumferential direction one side, the tip portion on the tire-circumferential direction one side of the enclosed region includes a low land portion in which the height of the land becomes lower step-wise or gradually, as approaching the tire-circumferential direction one side.
<B-3> The pneumatic tire as described in <B-1> or <B-2) includes a communication sipe that communicates from the other end of the second minor groove to the second major groove. It should be noted that the first sipe 150 of the above-mentioned embodiment is an example of the communication sipe in <B-3>.
<B-4> In the pneumatic tire as described in <B-3>, the width of the communication sipe is 0.6 mm or more and 1.2 mm or less.
<B-5> In the pneumatic tire as described in any one of <B-1> to <B-4>, the land includes a transverse slit that straddles the first minor groove and second minor groove, traverses the land and communicates with the first main groove and the second main groove. It should be noted that the first transverse slit 170 of the above-mentioned embodiment is an example of the transverse slit in <B-4>.
<B-6> In the pneumatic tire as described in <B-5> the width of the transverse slit is larger than both the width of the first minor groove and the width of the second minor groove.

According to the pneumatic tire related to the above <B>, it is possible to provide a pneumatic tire capable of obtaining both securing of snow traction and suppression of air-column resonance sound.

### <C>

Conventionally, pneumatic tires have been known that include a tread including a plurality of main grooves extending in the tire-circumferential direction and a plurality of lands extending in the tire-circumferential direction between the main grooves, and in which various grooves are formed in the lands. In this type of tire, although the traction performance such as during rainy weather is ensured by the drainage performance improving due to the main grooves, in addition to this, drainage is carried out by grooves such as slits formed in the lands and extending in directions intersecting the tire-circumferential direction. The present invention has an object of providing a pneumatic tire for which an improvement in drainage performance over conventional is achieved. The pneumatic tire according to <C> includes the following combinations.
<C-1> A pneumatic tire includes a tread including a land extending in a tire-circumferential direction, a first main groove disposed on a tire-axial direction one side of the land, a second main land disposed on a tire-axial direction other side of the land and having a wider width than the first main groove, and a slit formed in the land, in which
the slit includes
a first communication slit that traverses the land to communicate the first main groove with the second main groove, and includes a first opening that opens to the first main groove and a second opening that opens to the second main groove, and
the width of the first communication slit becomes larger as approaching the second opening from the first opening. It should be noted that the inside central main groove 700 of the above-mentioned embodiment is an example of the first main groove in <C-1>. The inside shoulder main groove 900 of the above-mentioned embodiment is an example of the second main groove in <C-1>. The inside intermediate slit 301 of the above-mentioned embodiment is an example of the slit in <C-1>. The second transverse slit 310 of the above-mentioned embodiment is an example of the first communication slit in <C-1>.
<C-2> In the pneumatic tire as described in <C-1>, the slit includes a second communication slit formed in a bent shape from the first main groove to the first communication slit, and communicating the first main groove with the first communication slit,
the second communication slit including
a first groove that communicates with the first main groove and extends in a direction intersecting the tire-circumferential direction, and
a second groove that communicates with the first communication slit and extends in the tire-circumferential direction, and
the first groove is deeper than the second groove. It should be noted that the bent slit 320 of the above-mentioned embodiment is an example of the second communication slit in <C-2>, and is the inside intermediate slit in <G12> and <G13> described later. The sloped portion 322 of the bent slit 320 of the above-mentioned embodiment is an example of the first groove in <C-2>. The linear portion 321 of the bent slit 320 of the above-mentioned embodiment is an example of the second groove in <C-2>.
<C-3> In the pneumatic tire as described in <C-2>, the slit includes a third communication slit that extends in a direction intersecting the tire-circumferential direction, communicates with the second main groove, and terminates within the land, and
the width of the third communication slit becomes narrower as approaching a terminal end from the opening to the second main groove. It should be noted that the third intermediate slit 330 of the above-mentioned embodiment is an example of the third communication slit in <C-3>.
<C-4> In the pneumatic tire as described in <C-3>, the third communication slit is disposed along an extension of the first groove.
<C-5> In the pneumatic tire as described in <C-3> or <C-4>, a sum total of an opening width of the first communication slit and an opening width of the second communication slit relative to the first main groove is smaller than a sum total of an opening width of the first communication slit and an opening width of the third communication slit relative to the second main groove.

According to the pneumatic tire related to the above <C>, it is possible to provide a pneumatic tire for which an improvement in drainage performance over conventional is achieved.

### <D>

Conventionally, pneumatic tires have been known that include a tread in which a tread pattern is formed by a plurality of grooves. As the plurality of grooves, for example, main grooves along the tire-circumferential direction, narrow grooves called sipes formed in the surface of a land between the plurality of main grooves, and extending in a direction intersecting the tire-circumferential direction, etc. can be exemplified. In this type of tire, the above-mentioned sipe may contribute to securing gripping force when traveling on a snowy road, i.e. snow traction, for example. Herein, a sufficient drainage property is sought in order for sufficient gripping force to be exhibited in the tire even during rainy weather travel. The present invention has an object of providing a pneumatic tire for which an improvement in the drainage property is possible due to sipes, together with an improvement in snow traction. The pneumatic tire according to <D> includes the following combinations.
<D-1> A pneumatic tire includes a tread that includes lands and a main groove extending in a tire-circumferential direction, in which
the lands include
an outside shoulder land disposed at a vehicle-width direction outer side, and an inside shoulder land disposed at a vehicle-width direction inner side in a vehicle mounted state,
the outside shoulder land includes an outside shoulder sipe extending in a direction intersecting the tire-circumferential direction,
the inside shoulder land includes an inside shoulder sipe extending in a direction intersecting the tire-circumferential direction,
the outside shoulder sipe has a shape at a tire surface including a straight shape or a curved shape, and includes a 3D shape in a depth direction, and
the inside shoulder sipe has a shape at a tire surface which is a wave shape.
<D-2> in the pneumatic tire as described in <D-1>, the inside shoulder sipe includes a 3D shape in a depth direction, and a period of the wave shape changes to be shorter in the depth direction.
<D-3> In the pneumatic tire as described in <D-1> or <D-2>, a sipe length of the outside shoulder sipe at a depth 50% relative to a depth of the main groove is within a range of +/−10% of a sipe length of the inside shoulder sipe at a depth 50% relative to the depth of the main groove.

According to the pneumatic tire related to the above <D>, it is possible to provide a pneumatic tire for which an improvement in the drainage property is possible due to sipes, together with an improvement in snow traction.

### <E>

In pneumatic tires, the drainage property improves and traction performance such as during rainy weather is ensured by the main grooves; however, drainage is also carried out by grooves such as slits formed in the lands, and extending in a direction intersecting the tire-circumferential direction. On the other hand, when traveling in the snow, although grooves such as slits contribute to securing snow traction accompanying ensuring road holding, conversely, a decline in turning stability may be of concern due to a decline in rigidity. The present invention has an object of providing an pneumatic tire for which turning stability can be also be secured, while snow traction is secured. The pneumatic tire according to <E> includes the following combinations.
<E-1> A pneumatic tire includes tread in which each of a vehicle-width direction outer side and a vehicle-width direction inner side is defined in a state mounted to a vehicle, in which
the tread includes
a land disposed more to the vehicle-width direction outer side than a tire equator, an outside main groove adjacent to a vehicle-width direction outer side of the land and extending in a tire-circumferential direction, and an inside main groove adjacent to a vehicle-width direction inner side of the land and extending in the tire-circumferential direction,
the land includes
a minor groove extending in the tire-circumferential direction, and disposed offset more to the vehicle-width outer side than a width-direction center of the land,
a first groove extending from a tire-circumferential direction one end of the minor groove in a direction intersecting the tire-circumferential direction, and communicating with the outside main groove,
a second groove extending from a tire-circumferential direction other end of the minor groove in a direction intersecting the tire-circumferential direction, and communicating with the inside main groove, and
a slit extending from the minor groove in a direction intersecting the tire-circumferential direction, and communicating with the outside main groove. It should be noted that the outside shoulder main groove 800 of the above-mentioned embodiment is an example of the outside main groove in <E-1>, and is the first shoulder main groove in <G7> described later. The outside central main groove 600 of the above-mentioned embodiment is an example of the inside main groove in <E-1>, and is the first central main groove in <G7> described later. The third minor groove 210 of the above-mentioned embodiment is an example of the minor groove in <E-1>, and is the outside intermediate minor groove in <G7> described later. The second sloped groove 220 of the above-mentioned embodiment is an example of the first groove in <E-1>. The third sloped groove 230 of the above-mentioned embodiment is an example of the second groove in <E-1>. The first intermediate slit 240 of the above-mentioned embodiment is an example of the slit in <E-1>, and is the first intermediate slit in <G7> described later.
<E-2> In the pneumatic tire as described in <E-1>, the minor groove includes, at one side thereof in the width direction, a shelf along the groove length direction.
<E-3> In the pneumatic tire as described in <E-1> or <E-2>, the land includes a sipe communicating with at least one among the outside main groove and the inside main groove. It should be noted that the third sipe 251, the fourth sipe 252, the fifth sipe 253 and the sixth sipe 254 in the above-mentioned embodiment are examples of the sipe in <E-3>.

According to the pneumatic tire related to the above <E>, it is possible to provide a pneumatic tire for which turning stability can be also be secured, while snow traction is secured.

### <F>

In pneumatic tires, the drainage property improves and traction performance such as during rainy weather is ensured by the main grooves; however, drainage is also carried out by grooves such as slits formed in the lands, and extending in a direction intersecting the tire-circumferential direction. On the other hand, an improvement in the drainage property will also contribute to turning stability. The present invention has an object of providing a pneumatic tire for which both improvements in the drainage property and turning stability are achieved over conventional.
<F-1> A pneumatic tire includes tread in which each of a vehicle-width direction outer side and a vehicle-width direction inner side is defined in a state mounted to a vehicle, in which
the tread includes a plurality of lands extending in the tire-circumferential direction, and aligned in the tire-axial direction,
the plurality of the lands includes
a central land,
an outside intermediate land on a vehicle-width direction outer side of the central land, and
an inside intermediate land on a vehicle-width direction inner side of the central land,
the central land includes a plurality of central minor grooves extending in the tire-circumferential direction,
the outside intermediate land includes one outside intermediate minor groove extending in the tire-circumferential direction, and
the inside intermediate land includes one inside intermediate minor groove extending in the tire-circumferential direction. It should be noted that the third minor groove 210 of the above-mentioned embodiment is an example of the outside intermediate minor groove in <F-1>. The linear portion 321 of the bent slit 320 of the above-mentioned embodiment is an example of the inside intermediate minor groove in <F-1>.
<F-2> In the pneumatic tire as described in <F-1>, the outside intermediate minor groove is disposed offset more to an outer side in a vehicle-width direction than a center in the width-direction of the outside intermediate land.
<F-3> In the pneumatic tire as described in <F-1> or <F-2>, a plurality of the central minor grooves are disposed at positions dividing the central land into substantially equal portions in the width direction.
<F-4> In the pneumatic tire as described in <F-3>, the central land includes two of the central minor grooves.
<F-5> In the pneumatic tire as described in any one of <F-1> to <F-4>, a length in the tire-circumferential direction of the inside intermediate minor groove is longer than a length of the outside intermediate minor groove in the tire-circumferential direction.

According to the pneumatic tire related to the above <F>, it is possible to provide a pneumatic tire for which both improvements in the drainage property and turning stability are achieved over conventional.

Furthermore, the present invention includes the pneumatic tire as described in the following <G1> to <G20>.
<G1> A pneumatic tire includes a tread including a plurality of lands extending in a tire-circumferential direction, and aligned in a tire-axial direction; a plurality of main grooves provided between a plurality of the lands, and a slit provided in the land, in which
the plurality of the lands includes
a central land,
a first intermediate land on a tire-axial direction one side of the central land, and
a second intermediate land on a tire-axial direction other side of the central land,
a first shoulder land on a tire-axial direction one side of the first intermediate land, and
a second shoulder land on a tire-axial direction other side of the second intermediate land
the plurality of the main grooves includes
a first central main groove between the central land and the first intermediate land,
a second central main groove between the central land and the second intermediate land,
a first shoulder main groove between the first intermediate land and the first shoulder land, and
a second shoulder main groove between the second intermediate land and the second shoulder land,
the slit includes a first slit formed in a state continuously extending from the first intermediate land and spanning the central land, the second intermediate land and the second shoulder land, and
the first slit includes a first curved portion that curves to either side in a tire-circumferential direction within a range from the first intermediate land through the central land to a middle of the second intermediate land, and includes a second curved portion that curves to an opposite side than the first curved portion in the tire-circumferential direction, within a range from middle of the second intermediate land to the second shoulder land.
<G2> In the pneumatic tire as described in <G1>, the slit includes a second slit that is provided in at least one among the central land, the first intermediate land and the second intermediate land, is substantially parallel to the first slit and extends in a direction intersecting the tire-circumferential direction, and having one end thereof that extends within the land.
<G3> In the pneumatic tire as described in <G1> or <G2>, the first curved portion and the second curved portion are formed continuously via an inflection point, the inflection point existing at a middle of the second intermediate land.
<G4> In the pneumatic tire as described in any one of <G1> to <G3>, in the tread,
each of a vehicle-width direction outer side and a vehicle-width direction inner side is defined in a state mounted to a vehicle,
the first shoulder land is an outside shoulder land disposed at the vehicle-width direction outer side,
the second shoulder land is an inside shoulder land disposed at the vehicle-width direction inner side,
the outside shoulder land includes an outside shoulder sipe extending in a direction intersecting the tire-circumferential direction,
the inside shoulder land includes an inside shoulder sipe extending in a direction intersecting the tire-circumferential direction,
the outside shoulder sipe has a shape at a tire surface including a straight shape or a curved shape, and includes a 3D shape in a depth direction, and
the inside shoulder sipe has a shape at a tire surface which is a wave shape.
<G5> In the pneumatic tire as described in <G4>, the inside shoulder sipe includes a 3D shape in a depth direction, and a period of the wave shape changes to be shorter in the depth direction.
<G6> In the pneumatic tire as described in <G4> or <G5>, a sipe length of the outside shoulder sipe at a depth 50% relative to a depth of the main groove is within a range of +/−10% of a sipe length of the inside shoulder sipe at a depth 50% relative to the depth of the main groove.
<G7> In the pneumatic tire as described in any one of <G1> to <G3>, in the tread,
each of a vehicle-width direction outer side and a vehicle-width direction inner side is defined in a state mounted to a vehicle,
the first intermediate land is an outside intermediate land disposed more to the vehicle-width direction outer side than a tire equator, and extending in the tire-circumferential direction,
the first shoulder main groove is an outside main groove adjacent to a vehicle-width direction outer side of the outside intermediate land and extending in the tire-circumferential direction,
the first central main groove is an inside main groove adjacent to a vehicle-width direction inner side of the outside intermediate land and extending in the tire-circumferential direction,
the outside intermediate land includes
an outside intermediate minor groove extending in the tire-circumferential direction, and disposed offset more to the vehicle-width direction outer side than a center in a width-direction of the outside intermediate land,
a first groove extending from a tire-circumferential direction one end of the outside intermediate minor groove in a direction intersecting the tire-circumferential direction, and communicating with the outside main groove,
a second groove extending from a tire-circumferential direction other end of the outside intermediate minor groove in a direction intersecting the tire-circumferential direction, and communicating with the inside main groove, and
a first intermediate slit extending from the outside intermediate minor groove in a direction intersecting the tire-circumferential direction, and communicating with the outside main groove.
<G8> In the pneumatic tire as described in <G7>, the outside intermediate minor groove includes a shelf along a groove length direction on one side in a width direction thereof.
<G9> In the pneumatic tire as described in <G7> or <G8>, the outside intermediate land includes a sipe communicating with at least one among the outside main groove and the inside main groove.
<G10> In the pneumatic tire as described in any one of <G1> to <G9>, the tread includes a central minor groove formed in the central land,
the central minor groove including:
a first minor groove that is adjacent to the first central main groove and extends in a tire-circumferential direction, and has one end at a tire-circumferential direction one side and one other end at a tire-circumferential direction other side, and
a second minor groove that is adjacent to the first minor groove at a side of the second central main groove in the tire-axial direction, and has one end at a tire-circumferential direction one side and one other end at a tire-circumferential direction other side,
the one end of the first minor groove and the one end of the second minor groove are connected by a connection groove, and
the other end of the first minor groove communicates with the second central main groove via a communication groove.
<G11> In the pneumatic tire as described in any one of <G1> to <G3>, in the tread,
each of a vehicle-width direction outer side and a vehicle-width direction inner side is defined in a state mounted to a vehicle,
the first intermediate land is an outside intermediate land on the vehicle-width direction outer side of the central land,
the second intermediate land is an inside intermediate land on the vehicle-width direction inner side of the central land,
the first central main groove is an outside main groove between the central land and the outside intermediate land,
the second central main groove is an inside main groove between the central land and the inside intermediate land,
the first shoulder groove is an outside shoulder main groove adjacent to an outer side in the vehicle-width direction of the outside intermediate land and extending in the tire-circumferential direction,
the second shoulder groove is an inside shoulder main groove adjacent to an outer side in the vehicle-width direction of the inside intermediate land and extending in the tire-circumferential direction,
the inside intermediate land includes an inside intermediate slit, and
the inside intermediate slit
includes a first communication slit that traverses the inside intermediate land and communicates the inside central main groove and the inside shoulder main groove, and includes a first opening that opens to the inside central main groove, and a second opening that opens to the inside shoulder main groove,
the first communication slit having a width that increases as approaching the second opening from the first opening.
<G12> In the pneumatic tire as described in <G11>, the inside intermediate slit includes a second communication slit formed in a bent shape from the inside central main groove to the first communication slit, and communicating the inside central main groove with the first communication slit,
the second communication slit includes
a first groove communicating with the inside central main groove, and extending in a direction intersecting the tire-circumferential direction, and
a second groove communicating with the first communication slit, and extending in the tire-circumferential direction, and
the first groove is deeper than the second groove.
<G13> In the pneumatic tire as described in <G12>, the inside intermediate slit includes a third communication slit extending in a direction intersecting the tire-circumferential direction, communicating with the inside shoulder main groove, and terminating within the land, and
the third communication slit has a narrower width as approaching a terminal end from an opening to the inside shoulder main groove.
<G14> In the pneumatic tire as described in <G13>, the third communication slit is disposed along an extension of the first groove.
<G15> In the pneumatic tire as described in <G13> or <G14>, a sum total of an opening width of the first communication slit and an opening width of the second communication slit relative to the inside central main groove is smaller than a sum total of an opening width of the first communication slit and an opening width of the third communication slit relative to the inside shoulder main groove.
<G16> In the pneumatic tire as described in any one of <G1> to <G3>, in the tread,
each of a vehicle-width direction outer side and a vehicle-width direction inner side is defined in a state mounted to a vehicle,
the first intermediate land is an outside intermediate land on a vehicle-width direction outer side of the central land,
the second intermediate land is an inside intermediate land on a vehicle-width direction inner side of the central land,
the central land includes a plurality of central minor grooves extending in the tire-circumferential direction,
the outside intermediate land includes one outside intermediate minor groove extending in the tire-circumferential direction, and
the inside intermediate land includes one inside intermediate minor groove extending in the tire-circumferential direction.
<G17> In the pneumatic tire as described in <G16>, the outside intermediate minor groove is disposed offset more to an outer side in a vehicle-width direction than a center in width-direction of the outside intermediate land.
<G18> In the pneumatic tire as described in <G16> or <G17>, a plurality of the central minor grooves are disposed at positions dividing the central land into substantially equal portions in the width direction.
<G19> In the pneumatic tire as described in <G18>, the central land includes two of the central minor grooves.
<G20> In the pneumatic tire as described in any one of <G16> to <G19>, a length in the tire-circumferential direction of the inside intermediate minor groove is longer than a length in the tire-circumferential direction of the outside intermediate minor groove.

What is claimed is:

1. A pneumatic tire comprising a tread including a plurality of lands extending in a tire-circumferential direction and aligned in a tire-axial direction; a plurality of main grooves provided between a plurality of the lands, and a slit provided in the land,
wherein the plurality of the lands includes
a central land,
a first intermediate land on a tire-axial direction one side of the central land;
a second intermediate land on a tire-axial direction other side of the central land;
a first shoulder land on the tire-axial direction one side of the first intermediate land; and
a second shoulder land on the tire-axial direction other side of the second intermediate land;
wherein the plurality of the main grooves include:
a first central main groove between the central land and the first intermediate land;
a second central main groove between the central land and the second intermediate land;
a first shoulder main groove between the first intermediate land and the first shoulder land; and
a second shoulder main groove between the second intermediate land and the second shoulder land,
wherein the slit includes a first slit formed in a state continuously extending from the first intermediate land and spanning the central land, the second intermediate land and the second shoulder land, and
wherein the first slit includes a first curved portion that curves to either side in a tire-circumferential direction within a range from the first intermediate land through the central land to a middle of the second intermediate land, and includes a second curved portion that curves to an opposite side than the first curved portion in the tire-circumferential direction, within a range from middle of the second intermediate land to the second shoulder land.

2. The pneumatic tire according to claim 1, wherein the slit includes a second slit that is provided in at least one among the central land, the first intermediate land and the second intermediate land, is substantially parallel to the first slit and extends in a direction intersecting the tire-circumferential direction, and having one end thereof that extends within the land.

3. The pneumatic tire according to claim 1, wherein the first curved portion and the second curved portion are formed continuously via an inflection point, the inflection point existing at a middle of the second intermediate land.

4. The pneumatic tire according to claim 1, wherein in the tread
each of a vehicle-width direction outer side and a vehicle-width direction inner side is defined in a state mounted to a vehicle,
the first shoulder land is an outside shoulder land disposed at the vehicle-width direction outer side,
the second shoulder land is an inside shoulder land disposed at the vehicle-width direction inner side,
the outside shoulder land includes an outside shoulder sipe extending in a direction intersecting the tire-circumferential direction,
the inside shoulder land includes an inside shoulder sipe extending in a direction intersecting the tire-circumferential direction,
the outside shoulder sipe has a shape at a tire surface including a straight shape or a curved shape, and includes a 3D shape in a depth direction, and
the inside shoulder sipe has a shape at a tire surface which is a wave shape.

5. The pneumatic tire according to claim 4, wherein the inside shoulder sipe includes a 3D shape in a depth direction, and a period of the wave shape changes to be shorter in the depth direction.

6. The pneumatic tire according to claim 4, wherein a sipe length of the outside shoulder sipe at a depth 50% relative to a depth of the main groove is within a range of +/−10% of a sipe length of the inside shoulder sipe at a depth 50% relative to the depth of the main groove.

7. The pneumatic tire according to claim 1, wherein
in the tread
each of a vehicle-width direction outer side and a vehicle-width direction inner side is defined in a state mounted to a vehicle,
the first intermediate land is an outside intermediate land disposed more to the vehicle-width direction outer side than a tire equator, and extending in the tire-circumferential direction,
the first shoulder main groove is an outside main groove adjacent to a vehicle-width direction outer side of the outside intermediate land and extending in the tire-circumferential direction,
the first central main groove is an inside main groove adjacent to a vehicle-width direction inner side of the outside intermediate land and extending in the tire-circumferential direction,
the outside intermediate land includes:
an outside intermediate minor groove extending in the tire-circumferential direction, and disposed offset more to the vehicle-width direction outer side than a center in a width-direction of the outside intermediate land,
a first groove extending from a tire-circumferential direction one end of the outside intermediate minor groove in a direction intersecting the tire-circumferential direction, and communicating with the outside main groove,
a second groove extending from a tire-circumferential direction other end of the outside intermediate minor groove in a direction intersecting the tire-circumferential direction, and communicating with the inside main groove, and
a first intermediate slit extending from the outside intermediate minor groove in a direction intersecting the tire-circumferential direction, and communicating with the outside main groove.

8. The pneumatic tire according to claim 7, wherein the outside intermediate minor groove includes, on one side in a width direction thereof, a shelf along a groove length direction.

9. The pneumatic tire according to claim 7, wherein the outside intermediate land includes a sipe communicating with at least one among the outside main groove and the inside main groove.

10. The pneumatic tire according to claim 1,
wherein the tread includes a central minor groove formed in the central land,
the central minor groove includes:
a first minor groove that is adjacent to the first central main groove and extends in a tire-circumferential direction, and has one end at a tire-circumferential direction one side and one other end at a tire-circumferential direction other side, and
a second minor groove that is adjacent to the first minor groove at a side of the second central main groove in the tire-axial direction, and has one end at a tire-circumferential direction one side and one other end at a tire-circumferential direction other side,
the one end of the first minor groove and the one end of the second minor groove are connected by a connection groove, and
the other end of the first minor groove communicates with the second central main groove via a communication groove.

11. The pneumatic tire according to claim 1, wherein
in the tread
each of a vehicle-width direction outer side and a vehicle-width direction inner side is defined in a state mounted to a vehicle,
the first intermediate land is an outside intermediate land on the vehicle-width direction outer side of the central land,
the second intermediate land is an inside intermediate land on the vehicle-width direction inner side of the central land,
the first central main groove is an outside central main groove between the central land and the outside intermediate land,
the second central main groove is an inside central main groove between the central land and the inside intermediate land,
the first shoulder groove is an outside shoulder main groove adjacent to an outer side in the vehicle-width direction of the outside intermediate land and extending in the tire-circumferential direction,
the second shoulder groove is an inside shoulder main groove adjacent to an outer side in the vehicle-width direction of the inside intermediate land and extending in the tire-circumferential direction,
the inside intermediate land includes an inside intermediate slit,
the inside intermediate slit
includes a first communication slit that traverses the inside intermediate land and communicates the inside central main groove and the inside shoulder main groove, and includes a first opening that opens to the inside central main groove, and a second opening that opens to the inside shoulder main groove, and
the first communication slit has a width that increases as approaching the second opening from the first opening.

12. The pneumatic tire according to claim 11,
wherein the inside intermediate slit includes a second communication slit formed in a bent shape from the inside central main groove to the first communication slit, and communicating the inside central main groove with the first communication slit,
wherein the second communication slit includes:
a first groove communicating with the inside central main groove, and extending in a direction intersecting the tire-circumferential direction, and
a second groove communicating with the first communication slit, and extending in the tire-circumferential direction, and
wherein the first groove is deeper than the second groove.

13. The pneumatic tire according to claim 12,
wherein the inside intermediate slit includes a third communication slit extending in a direction intersecting the tire-circumferential direction, communicating with the inside shoulder main groove, and terminating within the land, and
wherein the third communication slit has a narrower width as approaching a terminal end from an opening to the inside shoulder main groove.

14. The pneumatic tire according to claim 13, wherein the third communication slit is disposed along an extension of the first groove.

15. The pneumatic tire according to claim 13, wherein a sum total of an opening width of the first communication slit and an opening width of the second communication slit relative to the inside central main groove is smaller than a sum total of an opening width of the first communication slit and an opening width of the third communication slit relative to the inside shoulder main groove.

16. The pneumatic tire according to claim 1, wherein
in the tread,
each of a vehicle-width direction outer side and a vehicle-width direction inner side is defined in a state mounted to a vehicle,
the first intermediate land is an outside intermediate land on the vehicle-width direction outer side of the central land,
the second intermediate land is an inside intermediate land on the vehicle-width direction inner side of the central land,
the central land includes a plurality of central minor grooves extending in the tire-circumferential direction,
the outside intermediate land includes one outside intermediate minor groove extending in the tire-circumferential direction, and
the inside intermediate land includes one inside intermediate minor groove extending in the tire-circumferential direction.

17. The pneumatic tire according to claim 16, wherein the outside intermediate minor groove is disposed offset more to an outer side in a vehicle-width direction than a center in the width-direction of the outside intermediate land.

18. The pneumatic tire according to claim 16, wherein a plurality of the central minor grooves are disposed at positions dividing the central land into substantially equal portions in the width direction.

19. The pneumatic tire according to claim 18, wherein the central land includes two of the central minor grooves.

20. The pneumatic tire according to claim 19, wherein a length in the tire-circumferential direction of the inside intermediate minor groove is longer than a length in the tire-circumferential direction of the outside intermediate minor groove.
